(19) United States
(12) Patent Application Publication
(10) Pub. No.: US 2026/0144181 A1
(43) Pub. Date: May 28, 2026

(54) SYSTEMS AND METHODS FOR PREDICTING MATERIAL FLOW ISSUES AND CONTROL

(71) Applicant: DEERE & COMPANY, Moline, IL (US)

(72) Inventors: Bhanu Kiran Reddy Palla, Bettendorf, IA (US); Andrew J. Peterson, Ankeny, IA (US); Cary S. Hubner, Geneseo, IL (US); William D. Graham, East Moline, IL (US); Nathan R. Vandike, Geneseo, IL (US)

(21) Appl. No.: 19/448,397

(22) Filed: Jan. 14, 2026

Related U.S. Application Data
(63) Continuation of application No. 18/194,191, filed on Mar. 31, 2023, now Pat. No. 12,550,807.
(60) Provisional application No. 63/327,241, filed on Apr. 4, 2022.
(60) Provisional application No. 63/327,239, filed on Apr. 4, 2022.
(60) Provisional application No. 63/327,242, filed on Apr. 4, 2022.
(60) Provisional application No. 63/327,237, filed on Apr. 4, 2022.
(60) Provisional application No. 63/327,236, filed on Apr. 4, 2022.
(60) Provisional application No. 63/327,245, filed on Apr. 4, 2022.
(60) Provisional application No. 63/327,240, filed on Apr. 4, 2022.
(60) Provisional application No. 63/411,928, filed on Sep. 30, 2022.

(51) Int. Cl. A01B 79/00; A01D 41/127; G06V 20/10

(52) U.S. Cl. CPC A01B 79/005; A01D 41/127; G06V 20/188

(57) ABSTRACT

A predictive map is obtained by an agricultural system. The predictive map maps predictive material flow issue values at different geographic locations in a field. A geographic position sensor detects a geographic location of a mobile ground engaging machine at the field. A control system generates a control signal to control a controllable subsystem of the mobile ground engaging machine based on the geographic location of the mobile ground engaging machine and the predictive map.

### CROSS-REFERENCE TO RELATED APPLICATIONS

The present application is a continuation of and claims the benefit of U.S. nonprovisional patent application Ser. No. 18/194191 filed Mar. 31, 2023, which is based on and claims benefit to U.S. provisional patent applications Ser. No. 63/411,928, filed Sep. 30, 2022, Ser. No. 63/327,241, filed Apr. 4, 2022, Ser. No. 63/327,239, filed Apr. 4, 2022, Ser. No. 63/327,242, filed Apr. 4, 2022, Ser. No. 63/327,237, filed Apr. 4, 2022, Ser. No. 63/327,236, filed Apr. 4, 2022, Ser. No. 63/327,245, filed Apr. 4, 2022, and Ser. No. 63/327,240, filed Apr. 4, 2022, the content of which are hereby incorporated by reference in their entirety.

### FIELD OF THE DESCRIPTION

The present descriptions relates to mobile agricultural machines, particularly mobile agricultural planters configured to plant seeds at a field.

### BACKGROUND

There are a wide variety of different types of agricultural machines, such as mobile agricultural ground engaging machines. Some such mobile agricultural ground engaging machines include agricultural planting machines, agricultural tillage machine, or the like. Agricultural ground engaging machines have ground engaging tools that engage, and in some cases, penetrate the soil. For example, a planting machine may have ground opening tools for the generation of a furrow and ground closing tools for closing the opened furrow after a seed has dropped in. Tillage machines may include a variety of tillage tools, such as disks, shanks, tines, baskets, as well as various other harrowing or finishing tools. In some examples, planting machines may also include tillage tools. In some examples, these agricultural machines comprise a towing vehicle, such as a tractor, that tows an implement, such as a planting implement or a tillage implement.

As these machines operate at a field performing a respective operation, such as a planting operation or a tillage operation, parameters of the ground engaging tools, such as the positions (e.g., depth, angle, etc.) and downforce, are set and as the machine travels across the field, the ground engaging tools interact with the soil.

The discussion above is merely provided for general background information and is not intended to be used as an aid in determining the scope of the claimed subject matter.

### SUMMARY

A predictive map is obtained by an agricultural system. The predictive map maps predictive material flow issue values at different geographic locations in a field. A geographic position sensor detects a geographic location of a mobile ground engaging machine at the field. A control system generates a control signal to control a controllable subsystem of the mobile ground engaging machine based on the geographic location of the mobile ground engaging machine and the predictive map.

Example 1 is an agricultural ground engaging system comprising:
a control system that:
obtains a geographic location indicative of a geographic location of a mobile ground engaging machine at a field;
obtains a map that maps predictive material flow issue values to different geographic locations in the field; and
generates a control signal to control a controllable subsystem of the mobile ground engaging machine based on the geographic location of the mobile ground engaging machine and the map.

Example 2 is the agricultural ground engaging system of any or all previous examples and further comprising:
an in-situ sensor that detects a material flow issue value corresponding to a geographic location;
a predictive model generator that:
receives an information map that maps values of a characteristic corresponding to different geographic locations in the field;
generates a predictive material flow issue model that models a relationship between values of the characteristic and material flow issue values based on the material flow issue value detected by the in-situ sensor corresponding to the geographic location and a value of the characteristic in the information map at the geographic location to which the detected material flow issue value corresponds; and
a predictive map generator that generates, as the map, a functional predictive material flow issue map of the field that maps predictive material flow issue values to the different geographic locations in the field, based on the values of the characteristic in the information map and based on the predictive material flow model.

Example 3 is the agricultural ground engaging system of any or all previous examples wherein the information map comprises one of:
a topographic map that maps, as the values of the characteristic, topographic characteristic values to the different geographic locations in the field;
a residue moisture/toughness map that maps, as the values of the characteristic, residue moisture/toughness values to the different geographic locations in the field;
a soil moisture map that maps, as the values of the characteristic, soil moisture values to the different geographic locations in the field;
a soil type map that maps, as the values of the characteristic, soil type values to the different geographic locations in the field;
a vegetative index map that maps, as the values of the characteristic, vegetative index values to the different geographic locations in the field;
an optical map that maps, as the values of the characteristic, optical characteristic values to the different geographic locations in the field;
a prior harvesting operation map that maps, as the values of the characteristic, prior harvesting operation characteristic values to the different geographic locations in the field;
a prior tillage operation map that maps, as the values of the characteristic, prior tillage operation characteristic values to the different geographic locations in the field;
a historical yield map that maps, as the values of the characteristic, historical yield values to the different geographic locations in the field; or
a weed map that maps, as the values of the characteristic, weed values to the different geographic locations in the field.

Example 4 is the agricultural ground engaging system of any or all previous examples, wherein the controllable subsystem comprises a tool position subsystem having an actuator that is controllably actuatable to adjust a position of a tool of the mobile ground engaging machine, and wherein the control signal controls the actuator to adjust a position of the tool based on the geographic location of the mobile ground engaging machine and the map.

Example 5 is the agricultural ground engaging system of any or all previous examples, wherein the controllable subsystem comprises a propulsion subsystem that is controllable to adjust a speed of the mobile ground engaging machine, and wherein the control signal controls the propulsion subsystem to adjust a speed of the mobile ground engaging machine based on the geographic location of the mobile ground engaging machine and the map.

Example 6 is the agricultural ground engaging system of any or all previous examples, wherein the controllable subsystem comprises a downforce subsystem having an actuator that is controllably actuatable to adjust a downforce applied to a component of the ground engaging machine, and wherein the control signal controls the actuator to adjust a downforce applied to the tool based on the geographic location of the mobile ground engaging machine and the map.

Example 7 is the agricultural ground engaging system of any or all previous examples, wherein the controllable subsystem comprises a steering subsystem having that is controllable to control a travel path of the mobile ground engaging machine, and wherein the control signal controls the steering subsystem to control a travel path of the mobile ground engaging machine based on the geographic location of the mobile ground engaging machine and the map.

Example 8 is the agricultural ground engaging system of any or all previous examples, wherein the predictive material flow issue values are predictive of material accumulation on a ground engaging tool of the ground engaging machine.

Example 9 is the agricultural ground engaging system of any or all previous examples, wherein the predictive material flow issue values are predictive of plugging of a ground engaging tool or ground engaging tool assembly of the ground engaging machine.

Example 10 is a method of controlling a mobile ground engaging machine comprising:
receiving a predictive map of a field that maps predictive material flow issue values to different geographic locations in the field;
detecting a geographic location of the mobile ground engaging machine at the field; and
controlling the mobile ground engaging machine based on the geographic location of the mobile ground engaging machine and the predictive map.

Example 11 is the method of any or all previous examples wherein receiving the predictive map comprises:
detecting, with an in-situ sensor, a material flow issue value corresponding to a geographic location in the field;
receiving an information map that maps values a characteristic corresponding to the different geographic locations in the field;
generating a predictive material flow issue model that models a relationship between material flow issue values and values of the characteristic based on the detected material flow issue value and a value of the characteristic, in the information map, at the geographic location to which the material flow issue, detected by the in-situ sensor, corresponds; and
generating, as the predictive map, a functional predictive material flow issue map of the field, that maps predictive material flow issue values to the different geographic locations in the field based on values of the characteristic in an information map at those different geographic locations and the predictive material flow issue model.

Example 12 is the method of any or all previous examples wherein receiving the information map comprises receiving two or more information maps, each of the two or more information maps mapping values of a respective characteristic to the different geographic locations in the field;
wherein generating the predictive material flow issue model comprises, generating a predictive material flow issue model that models a relationship between the material flow issue values, and values of two or more respective characteristics based on the detected material flow issue value and a value of each of the two or more respective characteristics, in the two or more information maps, at the geographic location to which the material flow issue, detected by the in-situ sensor, corresponds; and
wherein generating the functional predictive material flow issue map comprises, generating a predictive material flow issue map that maps predictive material flow issue values to the different geographic locations in the field based on values of the two or more respective characteristics in the two or more information maps at those different locations and the predictive material flow issue model.

Example 13 is the method of any or all previous examples, wherein controlling the ground engaging machine comprises controlling a tool position actuator to control a position of a tool of the mobile ground engaging machine, based on the functional predictive material flow issue map and the geographic location of the mobile ground engaging machine.

Example 14 is the method of any or all previous examples, wherein controlling the ground engaging machine comprises controlling a downforce actuator to control a downforce applied to a tool the mobile ground engaging machine, based on the functional predictive material flow issue map and the geographic location of the mobile ground engaging machine.

Example 15 is the method of any or all previous examples, wherein controlling the ground engaging machine comprises controlling a steering subsystem of the mobile ground engaging machine, based on the functional predictive material flow issue map and the geographic location of the mobile ground engaging machine.

Example 16 is a mobile ground engaging machine comprising:
a controllable subsystem;
a geographic position sensor that detects a geographic location of the mobile ground engaging machine in a field; and
a control system that:
obtains a map of the field that maps predictive material flow issue values to different geographic locations in the field; and
generates a control signal to control the controllable subsystem based on the geographic location of the mobile ground engaging machine and a predictive material flow issue value in the map.

Example 17 is the mobile ground engaging machine of any or all previous examples and further comprising:
a communication system that receives an information map that includes values of a characteristic corresponding to the different geographic locations in the field;
an in-situ sensor that detects a material flow issue value corresponding to a geographic location at the field;
a predictive model generator that generates a predictive material flow issue model that models a relationship between the characteristic and the material flow issue based on the material flow issue value, detected by the in-situ sensor, corresponding to the geographic location and a value of the characteristic in the information map at the geographic location to which the detected material flow issue value corresponds; and
a predictive map generator that generates, as the map, a functional predictive material flow issue map of the field, that maps predictive material flow issue values to the different geographic locations in the field, based on the values of the characteristic in the information map and based on the predictive material flow issue model.

Example 18 is the mobile ground engaging machine of any or all previous examples, wherein the controllable subsystem comprises a tool position subsystem that is controllable to vary a position of a ground engaging tool of the mobile ground engaging machine and wherein the control signal controls the tool position subsystem to adjust a position of the ground engaging tool based on the geographic location of the mobile ground engaging machine and the predictive material flow issue value in the map.

Example 19 is the mobile ground engaging machine of any or all previous examples, wherein the controllable subsystem comprises a downforce subsystem that is controllable to adjust a downforce applied to a component of the mobile ground engaging machine and wherein the control signal controls the downforce subsystem to adjust a downforce applied to the component based on the geographic location of the mobile ground engaging machine and the predictive material flow issue value in the map.

Example 20 is the mobile ground engaging machine of any or all previous examples, wherein the controllable subsystem comprises a steering subsystem that is controllable to adjust a route of the mobile ground engaging machine and wherein the control signal controls the steering subsystem to adjust a route of the mobile ground engaging machine based on the geographic location of the mobile ground engaging machine and the predictive material flow issue value in the map.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a partial top view and partial block diagram of one example of an agricultural system architecture that includes a mobile agricultural ground engaging machine, including an agricultural ground engaging tool implement and a towing vehicle.

FIG. 2 is a side view showing one example of a row unit of the agricultural ground engaging tool implement illustrated in FIG. 1.

FIG. 3 is a side view showing another example of a row unit that can be used with the agricultural ground engaging tool implement illustrated in FIG. 1.

FIG. 4 is a perspective view of a portion of a seed metering system.

FIG. 5 shows an example of a seed delivery system that can be used with a seed metering system.

FIG. 6 shows an example of a seed delivery system that can be used with a seed metering system.

FIG. 7 is a side view showing one example of an agricultural ground engaging machine that can be used with the agricultural ground engaging system architecture shown in FIG. 1.

FIG. 8 is a perspective view showing one example of a row unit of the agricultural ground engaging machine illustrated in FIG. 7.

FIG. 9 is a side view showing one example of a ground engaging tool implement.

FIG. 10 is a block diagram showing some portions of an agricultural ground engaging system architecture, including a mobile agricultural ground engaging machine, in more detail, according to some examples of the present disclosure.

FIG. 11 is a block diagram showing one example of a predictive model generator and predictive map generator.

FIGS. 12A-12B (collectively referred to herein as FIG. 12) show a flow diagram illustrating one example of operation of an agricultural ground engaging system architecture in generating a map.

FIG. 13 is a block diagram showing one example of a mobile agricultural ground engaging machine in communication with a remote server environment.

FIGS. 14-16 show examples of mobile devices that can be used in an agricultural ground engaging system.

FIG. 17 is a block diagram showing one example of a computing environment that can be used in an agricultural ground engaging system.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

In one example, the present description relates to using in-situ data taken concurrently with an operation, in combination with prior or predicted data, such as prior or predicted data represented in a map, to generate a predictive model and a predictive map, such as a predictive material flow issue model and predictive material flow issue map. In some examples, the predictive material flow issue map can be used to control a mobile machine.

Mobile agricultural ground engaging machines, such as mobile agricultural planting machines or mobile agricultural tillage machines, include ground engaging tools that engage or interact with the soil at a field over which the machine travels. During operation, a mobile agricultural ground engaging machine may experience material flow issues, such as accumulation of material on the ground engaging tools or plugging of the ground engaging tools. During such operations, material, such as soil/dirt, residue (e.g., plant residue), debris, as well as other material, may accumulate on the ground engaging tools. In some examples, such accumulation may lead to plugging, for instance, one or more tools or tool assemblies (e.g., row units, tool gangs, etc.) may become plugged when the accumulation reaches a level such that the space between the individual tools or tool assemblies is filled with accumulated material. In some examples, a tool can be said to be plugged when the accumulation is such that the tool is prevented from performing its task. For instance, an opener or closer (e.g., opening or closing disk) may be plugged when the accumulation is such that the opener or closer can no longer rotate. Generally, ground engaging tools on planting and tillage machines operate to interact with and shift material on the field, without accumulating such material. This is in contrast to other types of operations, such as construction operations that include ground engaging tools, such as buckets, that attempt to accumulate material. Thus, ground engaging tools in planting and tillage machines can be said to have a material flow in that, in ideal operation, material moves around the ground engaging tools or is moved by the ground engaging tools, but is ideally not accumulated on the ground engaging tools.

Material flow issues, such as accumulation of material on ground engaging tools and plugging of ground engaging tools, can lead to various deleterious effects in tillage and planting operations. For instance, accumulated material (dirt, residue, debris, etc.) on the tools may eventually break up, such as in clumps, and may fall backwards and relocate at an undesirable location, such as in a furrow (or trench) or a tillage bed. Additionally, accumulation may cause the tools to push material around the field or scrape the soil which may damage the tools or lead to poor conditioning of the field. Further, accumulation may affect the ability of the tool to properly engage the soil, thus leading to improper depths, poor condition of the soil, as well as various other deleterious effects. Further, accumulation of material, particularly plugging (where accumulated material fills a space between individual tools or between tool units, or both), may have deleterious effects on individual control of the individual tools or tool units (because they are “stuck” together), they overload the actuator, or the tools are prevented from rotating or rotating desirably. Additionally, accumulation may lead to increased wear, for instance, actuators that operate to actuate the tools may be stressed by the increased weight due to accumulated material. Additionally, the machine may slow or stall due to the increased draft caused by the material plugging.

In some cases, sensor technology can be employed to detect material flow issues, and subsequent control can be undertaken based on the sensor readings. However, such control can suffer from latencies in sensor readings as well as machine latencies. Thus, it would be desirable to provide a system that allows for pro-active control that can maintain desired performance through variable conditions. Pro-active control reduces (or eliminates) the problems associated with latency.

In one example, the present description relates to obtaining a map such as a topographic map. The topographic map includes geolocated values of topographic characteristics (topographic characteristic values, sometimes referred to herein as topographic values) across different locations at a field of interest. For example, the topographic map can include elevation values indicative of the elevation of the field at various locations, as well as slope values indicative of the slope of the field at various locations. The topographic map, and the values therein, can be based on historical data, such as topographic data detected during previous operations at the worksite by the same mobile machine or by a different mobile machine. The topographic map, and the values therein, can be based on fly-over or satellite-based sensor data, such as lidar data of the worksite, as well as scouting data provided by a user or operator such as from a scouting operation of the worksite. These are merely some examples. The topographic map can be generated in a variety of other ways.

In one example, the present description relates to obtaining a map such as a residue moisture/toughness map. The residue moisture/toughness map includes geolocated values of residue moisture or toughness across different geographic locations in a field of interest. The residue moisture/toughness map can be a predictive map that predicts residue moisture/toughness values based on one or more of sensor data from a prior operation, such as a prior harvesting operation in which material other than grain (MOG) moisture sensors generate sensor data indicative of vegetation material moisture, power consumption sensors (e.g., voltage sensors, amp sensors) or force sensors (e.g., fluid pressure sensors, torque sensors) detect an amount of power or force used to drive a residue chopper, imaging systems or optical sensors detect a residue chop quality, optical or vegetative index data (such as from aerial images of the field) that may indicate the health or color of the material on the field, information from seed providers, operator or user input data, as well as various modeling. These are merely some examples. The residue moisture/toughness map can be generated in a variety of other ways.

In one example, example, the present description relates to obtaining a map, such as a soil moisture map. A soil moisture map includes geolocated values of soil moisture across different geographic locations in a field of interest. The soil moisture map, and the values therein, can be based on soil moisture values detected during prior operations at the field such as prior operations by the same mobile machine or a different mobile machine. The soil moisture values can be based on detected soil moisture data from sensors disposed in the field. Thus, the soil moisture values can be measured soil moisture values. The soil moisture map, and the values therein, can be a predictive soil moisture map with predictive soil moisture values. In one example, the predictive soil moisture values can be based on images generated during a survey of the field, such as an aerial survey of the field. In another example, the predictive soil moisture map is generated by obtaining a map of the field that maps a characteristic to different locations at the field, and a sensed in-situ soil moisture (such as soil moisture data obtained from a data signal from a soil moisture sensor) and determining a relationship between the obtained map, and the values therein, and the in-situ sensed soil moisture data. The determined relationship, in combination with the obtained map(s), is used to generate a predictive soil moisture map having predictive soil moisture values. The soil moisture map can be based on historical soil moisture values. The soil moisture map can be based on soil moisture modeling, which may take into account, among other things, weather characteristics and characteristics of the field, such as topography, soil type, remaining crop stubble/residue, etc. These are merely some examples. The soil moisture map can be generated in a variety of other ways.

In one example, the present description relates to obtaining a map, such as a soil type map. A soil type map includes geolocated values of soil type across different geographic locations in a field of interest. Soil type can refer to taxonomic units in soil science, wherein each soil type includes defined sets of shared properties. Soil types can include, for example, sandy soil, clay soil, silt soil, peat soil, chalk soil, loam soil, and various other soil types. Thus, the soil type map provides geolocated values of soil type at different locations in the field of interest which indicate the type of soil at those locations. The soil type map can be generated on the basis of data collected during another operation on the field of interest, for example, previous operations in the same season or in another season. The machines performing the previous operation can have on-board sensors that detect characteristics indicative of soil type. Additionally, operating characteristics, machine settings, or machine performance characteristics during previous operations can be indicative of soil type. In other examples, surveys of the field of interest can be performed, either by various machines with sensors such as imaging systems (e.g., an aerial survey) or by humans. For example, samples of the soil at the field of interest can be taken at one or more locations and observed or lab tested to identify the soil type at the different location(s). In some examples, third-party service providers or government agencies, for instance, the Natural Resources Conservation Services (NRCS), the United States Geological Survey (USGS), as well as various other parties may provide data indicative of soil type at the field of interest. These are merely examples. The soil type map can be generated in a variety of other ways.

In one example, the present description relates to obtaining a map, such as a vegetative index (VI) map. A VI map includes geolocated VI values across different geographic locations in the field of interest. VI values may be indicative of vegetative growth or vegetation health, or both. One example of a vegetative index includes a normalized difference vegetation index (NDVI). There are many other vegetative indices that are within the scope of the present disclosure. In some examples, a vegetative index may be derived from sensor readings of one or more bands of electromagnetic radiation reflected by the plants or plant matter. Without limitations, these bands may be in the microwave, infrared, visible, or ultraviolet portions of the electromagnetic spectrum. A VI map can be used to identify the presence and location of vegetation (e.g., crop, weeds, other plant matter, etc.). The VI map may be generated prior to the current operation or the current operation, such as after the most recent previous operation (e.g., harvest or tillage) and prior to the current operation. In other examples, the VI map may be generated during a previous growing season, such as the most recent previous growing season. Thus, the VI map may show vegetative index values that correspond to vegetation in the previous growing season, vegetation on the field after harvest, such as cover crop, weeds, and/or residue from the harvest operation. The amount of vegetation on the field in the previous growing season may be an indicator of eventual residue. These are merely some examples. The VI map can be generated in a variety of other ways.

In one example, the present description relates to obtaining a map, such as an optical map. An optical map illustratively includes geolocated electromagnetic radiation values (or optical characteristic values) across different geographic locations in a field of interest. Electromagnetic radiation values can be from across the electromagnetic spectrum. This disclosure uses electromagnetic radiation values from infrared, near-infrared (NIR), visible light and ultraviolet portions of the electromagnetic spectrum as examples only and other portions of the spectrum are also envisioned. An optical map may map datapoints by wavelength (e.g., a vegetative index). In other examples, an optical map identifies textures, patterns, color, shape, or other relations of data points. Textures, patterns, or other relations of data points can be indicative of presence or identification of vegetation (live or dead) on the field (e.g., crops, weeds, other plant matter, such as residue, etc.). Additionally, or alternatively, an optical map may identify the presence of standing water or wet spots on the field. The optical map can be derived using satellite images, optical sensors on flying vehicles such as UAVS, or optical sensors on a ground-based system, such as another machine operating in the field prior to the current tillage operation. In some examples, optical characteristic maps may map three-dimensional values as well such as vegetation height when a stereo camera or lidar system is used to generate the map. The optical map may be generated prior to the current operation, such as after the most recent previous operation (e.g., harvest or tillage) and prior to the current operation. In other examples, the optical map may be generated during a previous growing season, such as the most recent previous growing season or from an earlier season, such as post-harvest in an earlier year to indicate residue after the harvest in the earlier year. These are merely some examples. The optical characteristic map can be generated in a variety of other ways.

In one example, the present description relates to obtaining a map such as a prior operation map. The prior operation map includes geolocated values of prior operation characteristics across different geographic locations in a field of interest. Prior operation characteristics can include characteristics detected by sensors during prior operations at the field, such as characteristics of the field, characteristics of vegetation on the field, characteristics of the environment, as well as operating parameters of the machines performing the prior operations. In other examples, the prior operation map can be based on data provided by an operator or user. These are merely some examples. The prior operation map can be generated in a variety of other ways.

One example of a prior operation map is a prior harvesting operation map. The prior harvesting operation map includes geolocated values of prior harvesting operation characteristics across different geographic locations in a field of interest, such as characteristics detected by sensors during a prior harvesting operation. For example, characteristics of the field, characteristics of the vegetation at the field, characteristics of the environment, as well as operating parameters of the agricultural harvesting machine. For example, sensors may detect harvesting operating parameters that indicate the amount of residue left on the field from a harvesting operation, such as header height, separating system parameters, cleaning system parameters, residue handling system parameters (e.g., residue chopper parameters and/or residue spread parameters), as well as various other parameters, such as the power consumption of the residue chopper or residue spreader or the force used to drive the residue chopper or residue spreader. Thus, a prior operation map in the form of a prior harvesting operation map may be used to indicate or derive residue characteristics at the field of interest. These are merely some examples. The prior harvesting operation map can be generated in a variety of other ways.

Another example of a prior operation map is a prior tillage operation map. The prior tillage operation map includes geolocated values of prior tillage operation characteristics across different geographic locations in a field of interest, such as characteristics detected by sensors during a prior tillage operation. For example, characteristics of the field, characteristics of the vegetation at the field, characteristics of the environment, as well as operating parameters of the agricultural tillage machine. For example, the tillage machine may be equipped with sensors that can detect characteristics of debris on the field after tillage, such as the presence, distribution and size of dirt clods, residue, and various other debris. Thus, a prior operation map in the form of a prior tillage operation map may be used to indicate or derive obstacle characteristics (e.g., residue characteristics, etc.) at the field of interest. In another example, the tillage machine may be equipped with sensors that detect characteristics of the soil, such as bulk density or compaction. Thus a prior operation map in the form of a prior tillage operation may be used to indicate or derive soil characteristics, such as bulk density or compaction at the field of interest. In another example, the tillage machine may be equipped with sensors that detect operating parameters of the tillage machine, such as where tilling occurred or did not occur, or both, as well as operating depth of the tillage tools. These are merely some examples. The prior tillage operation map can be generated in a variety of other ways.

It will be understood that a prior operation map, as used herein, can be a prior harvesting operation map or a prior tillage operation map, or both. Accordingly, prior operation characteristic values can be prior harvesting operation characteristic values or prior tillage operation characteristic values, or both.

In one example, the present description relates to obtaining a map, such as a historical yield map. A historical yield map includes geolocated values of historical yield across different geographic locations in a field of interest. The historical yield map may be derived from sensor readings taken during a previous harvesting operation (e.g., the most immediate harvesting operation prior to the current tillage operation). For example, a harvesting machine may include yield sensors that provide sensor data indicative of yield, such as mass flow sensors, mass sensors (e.g., load sensors) that detect a mass of the harvested material in an on-board harvested material receptacle (e.g., an on-board grain tank). In other examples, the yield from the previous harvest may be calculated after the operation is completed, such as by an operator or user, and that data may be provided to generate the historical yield map. These are merely some examples. The historical yield map can be generated in a variety of other ways.

In one example, the present description relates to obtaining a map, such as a weed map. The weed map includes geolocated weed values across different geographic locations at a field of interest. The weed values may indicate one or more of weed intensity and weed type. Without limitation, weed intensity may include at least one of weed presence, weed population, weed growth stage, weed biomass, weed moisture, weed density, a height of weeds, a size of weed plants, an age of weeds, and health condition of weeds at locations in the field of interest. Without limitation, weed type may include weed genotype information (e.g., weed species) or more broad categorization of type, such as vine type weed and non-vine type weed. The weed map may derived from sensor readings taken during a prior operation, performed by a machine, at the field of interest or taken during an aerial survey of the field of interest (e.g., drone survey, plane survey, satellite survey, etc.). These machines may be outfitted with one or more different types of sensors, such as imaging systems (e.g., cameras), optical sensors, ultrasonic sensors, as well as sensors that detect one or more bands of electromagnetic radiation reflected by the plants on the field of interest. Alternatively, or additionally, the weed map may be derived from vegetative index values at the field of interest (such as vegetative index values in a vegetative index map). One example of a vegetive index is a normalize difference vegetation index (NDVI). There are many other vegetative indices that are within the scope of the present disclosure, including, but not limited to, a leaf area index (LAI). These are merely some examples. The weed map can be generated in a variety of other ways.

In one example, the present description relates to obtaining in-situ data from in-situ sensors on the mobile agricultural machine taken concurrently with an operation. The in-situ sensor data can include material flow issue (MFI) data generated by material flow issue (MFI) sensors. MFI sensors may include one or more sensors that observe at the field, such as one or more of imaging systems (e.g., mono or stereo cameras), optical sensors, lidar, radar, ultrasonic sensors, thermal or infrared sensors, acoustic or vibration sensors that detect noise or vibration of the ground engaging tools, as well as various other sensors, such as sensors that emit and/or receive electromagnetic radiation. For example, MFI sensors, in the form of observation sensors, may detect accumulated material on the ground engaging tools, as well as plugging of the ground engaging tools. In other examples, the observation MFI sensors may observe the field ahead of, around, or behind the tools (or behind the machine) to detect material flow issue characteristics, such as clumps of material left behind the tools, movement (or lack thereof) of material moving around the tools, scraping of the ground, pushing of material, bunching of material, as well as various other characteristics. In other examples, the observation MFI sensors may observe noise or vibration of the ground engaging tools, for instance, the noise or vibration of the tools may vary as material is accumulated on the tools. Such noise or vibration sensors may include accelerometers, microphones, as well as various other sensors.

Additionally, or alternatively, MFI sensors may include one or more sensors that detect control inputs, that is, inputs provided by an operator, user, or control system to control operation of the machine. For example, when material flow issues (e.g., accumulation, plugging, etc.) occur or may occur, the operator, user, or control system may provide control inputs, such as modifying a route of the machine such as to avoid or get out of a spot on the field, such as a wet spot, or to go over a spot multiple times, slowing or stopping the machine, adjusting downforce on items on the implement (e.g., row cleaners), raising the tool, such as to disengage the tool from the ground completely, rapidly raising and lowering a tool or tool assembly (e.g., to “shake” off accumulated material), as well as various other control inputs.

The present discussion proceeds, in some examples, with respect to systems that obtain one or more maps of a field, such as one or more of a topographic map, a residue moisture/toughness map, a soil moisture map, a soil type map, a vegetative index (VI) map, an optical map, a prior operation map (e.g., a prior harvesting operation map or a prior tillage operation map, or both), a historical yield map, a weed map, as well as various other types of maps and also use an in-situ sensor to detect a variable indicative of an agricultural characteristic value, such as a material flow issue value. The systems generate a model that models a relationship between the values on the obtained map(s) and the output values from the in-situ sensor. The model is used to generate a predictive map that predicts agricultural characteristic values, such as material flow issue values. The predictive map, generated during an operation, can be presented to an operator or other user or used in automatically controlling a mobile agricultural ground engaging machine during an operation, or both. In some examples, the predictive map can be used to control one or more operating parameters of the mobile agricultural ground engaging machine during an operation.

While the various examples described herein proceed with respect to certain example agricultural ground engaging machines, it will be appreciated that the systems and methods described herein are applicable to various other types of agricultural ground engaging machines including various other agricultural planting machines and agricultural tillage machines, not explicitly shown herein.

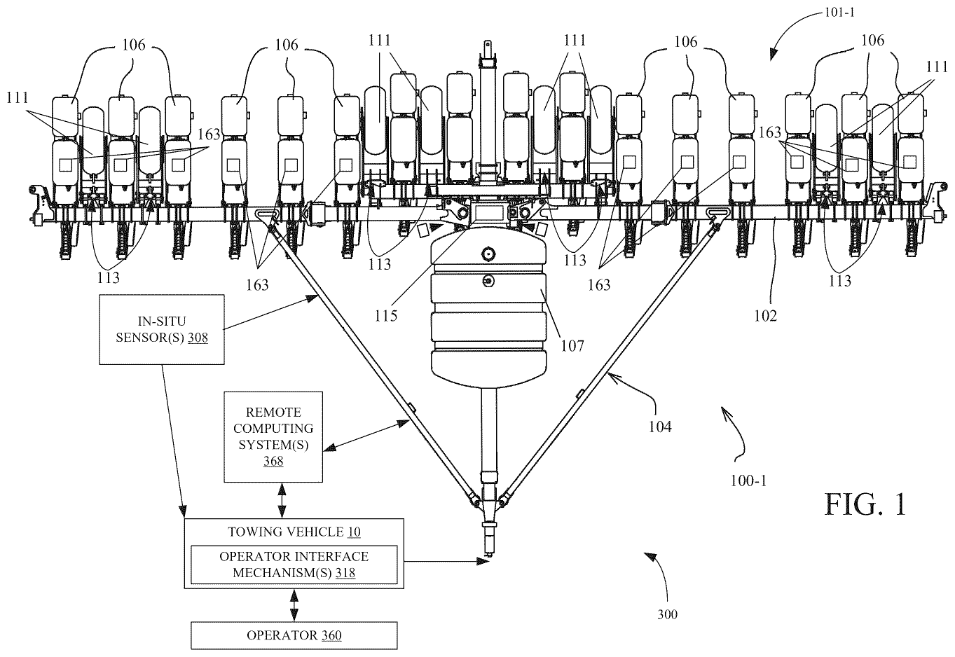

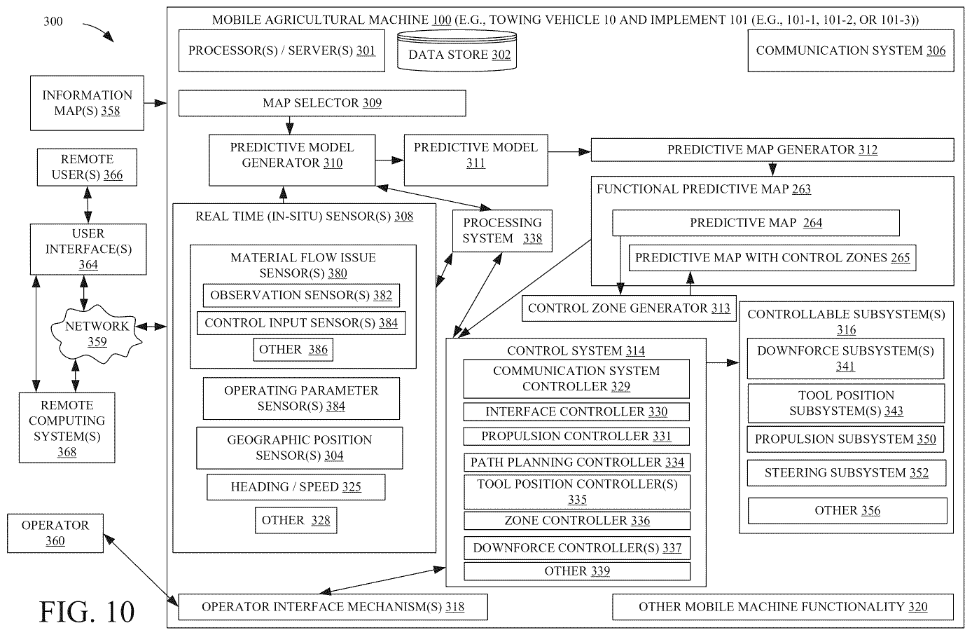

FIG. 1 is a partial top view, partial block diagram of one example of an agricultural ground engaging (e.g., planting, tillage, etc.) system architecture 300 that includes, as a mobile agricultural ground engaging machine 100, a mobile agricultural planting machine 100-1 that includes, as a ground engaging tool implement 101, planting implement 101-1, illustratively in the form of a row planter implement, and towing vehicle 10 that is operated by an operator 360. In the illustrated example, agricultural system architecture 300 also includes a remote computing system 368. FIG. 1 also illustrates that mobile agricultural planting machine 100-1 can include one or more in-situ sensors 308 which sense characteristic values. In-situ sensors 308 will be discussed in greater detail below. Various components of agricultural system architecture 300 (shown in more detail in FIG. 10) can be on individual parts of mobile agricultural ground engaging machine 100, centrally located on ground engaging tool implement 101, towing vehicle 10, or remote computing systems 368, or can be distributed in various ways across two or more of ground engaging tool implement 101, towing vehicle 10, and remote computing systems 368. Operator 360 can illustratively interact with operator interface mechanisms 218 to manipulate and control towing vehicle 10, remote computing systems 368, and at least some portions of planting implement 101.

Planting implement 101-1 is a row crop planting machine that illustratively includes a toolbar 102 that is part of a frame 104. Sensors 308 can be mounted to toolbar 102 or frame 104, or both. FIG. 1 also shows that a plurality of planting row units 106 are mounted to the toolbar 102. Agricultural planter 101-1 can be towed behind towing vehicle 10, such as a tractor. FIG. 1 shows that material, such as seed, fertilizer, etc. can be stored in a tank 107 and pumped, using one or more pumps 115, through supply lines to the row units. The seed, fertilizer, etc., can also be stored on the row units themselves. As shown in the illustrated example of FIG. 1, each row unit can include a controller 163 which can be used to control operating parameters of each row unit, such as the downforces, operating depth, as well as various other operating parameters. Planting implement 101-1 can also include a set of frame wheels 111, attached to tool bar 102 or another frame, that support the planting implement 101-1 over the surface at which it operates. Planting implement 101-1 can also include a suspension subsystem. For instance, frame wheels can include a respective controllable suspension 113 (e.g., air suspension, hydraulic suspension, electromechanical suspension, etc.) which can be controllably adjusted, such as by controlling an amount or pressure of fluid (e.g., air or hydraulic fluid) or controlling resistance. The frame wheel actuators 113 are controllable to, among other things, raise and lower wheels 111 to raise and lower toolbar 102 or frame 104.

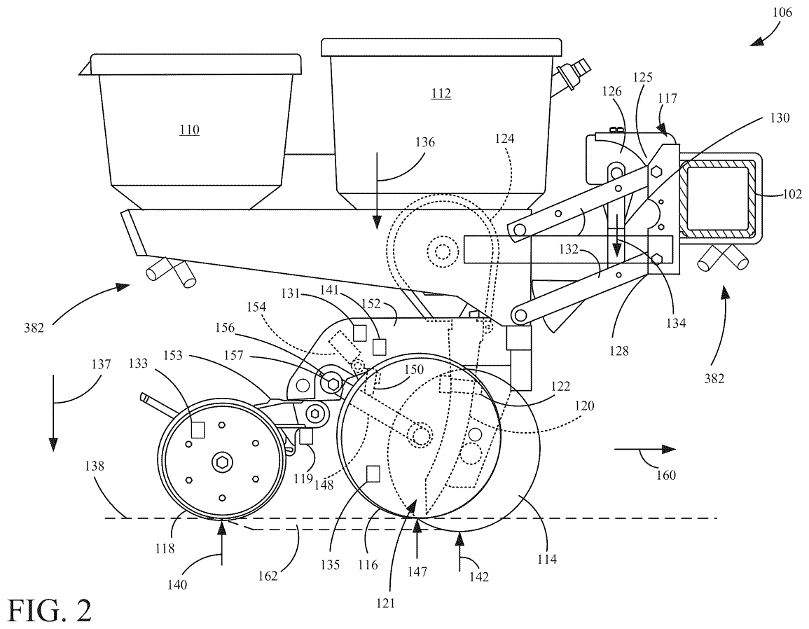

FIG. 2 is a side view showing one example of a row unit 106. In the example shown in FIG. 2, row unit 106 illustratively includes a chemical tank 110 and a seed storage tank 112. Row unit 106 also illustratively includes, as ground engaging tools, a disk opener 114 (that opens a furrow 162), a set of gauge wheels 116, and a set of closing wheels 118 (that close furrow 162). Seeds from tank 112 are fed by gravity into a seed meter 124. The seed meter 124 controls the rate which seeds are dropped into a seed tube 120 or other seed delivery system, such as a brush belt or flighted brush belt (both shown below) from seed storage tank 112. The seeds can be sensed by a sensor system 119 or sensor 122, or both.

In one example, sensor system 119 is an observation sensor system that includes one or more sensors, such as one or more imaging systems (e.g., stereo or mono cameras), optical sensors, lidar, radar, ultrasonic sensors, as well as various other types of sensors. Sensor system 119 observes the furrow 162 opened by row unit 106 and can detect various characteristics of the furrow, including but not limited to depth of the furrow 162. In some examples, sensor system 119 may also observe the tools (e.g., closing wheels 118, gauge wheels 116, furrow opener 114) of row unit 106 or the area around the tools, or both. Thus, in some examples, sensor system 119 may detect material flow issues.

As illustrated in FIG. 2, row unit 106 can also include one or more observation sensor systems 382 that detect material flow issues, such as accumulation of material on tools and plugging of tools or plugging of a tool assembly (e.g., row unit plugging). Observation sensor systems 382 can include one or more sensors, such as one or more imaging systems (e.g., mono or stereo cameras), optical sensors, radar, lidar, ultrasonic sensors, thermal or infrared sensors, acoustic or vibration sensors that detect noise or vibration of the ground engaging tools, as well as various other sensors, such as sensors that emit and/or receive electromagnetic radiation. In some examples, observation sensor systems 382 can detect the tools directly, such as to detect accumulated material on the tools and to detect plugging of the tools. In other examples, observation sensor systems 382 may detects other characteristics indicative of material accumulation or plugging, such as pushing of material, scraping of the soil behind the tools, poor tillage bed quality, movement (or lack thereof) of material around the tools), clumps of material behind the tool, as well as various other characteristics. Thus, it will be understood that observation sensor systems 382 can detect or have a field of view that includes ground around the tools or the tools themselves, or both. Additionally, while the example shown in FIG. 2 illustrates observation sensor systems 382 being disposed on implement row unit 106, in other examples, the observation sensor systems 382 can be disposed, alternatively or additionally, on other parts of implement 101-1 or on other parts of machine 100-1, such as on towing vehicle 10. Further, and as will be discussed in more detail in FIG. 10, machine 100 can include other types of material flow issue sensors 380, such as control input sensors 384.

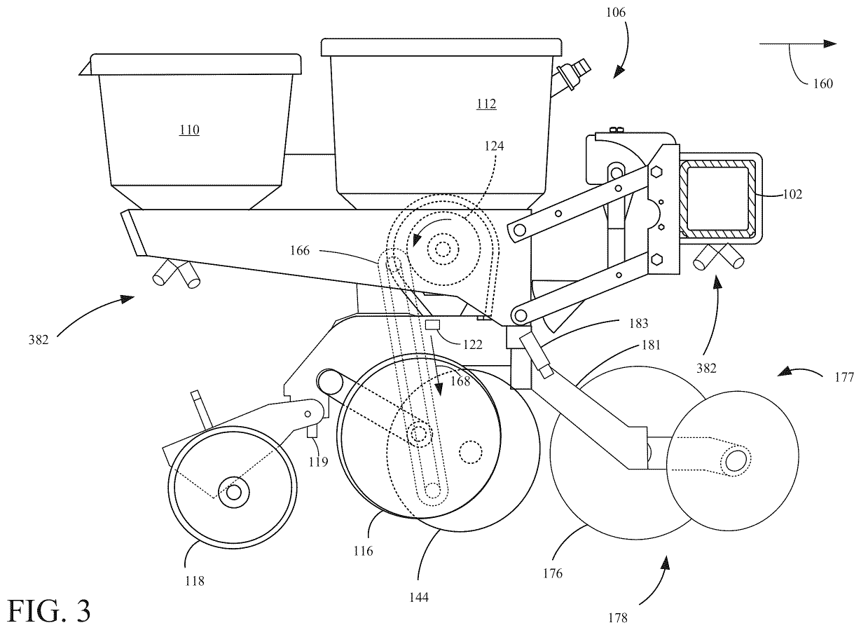

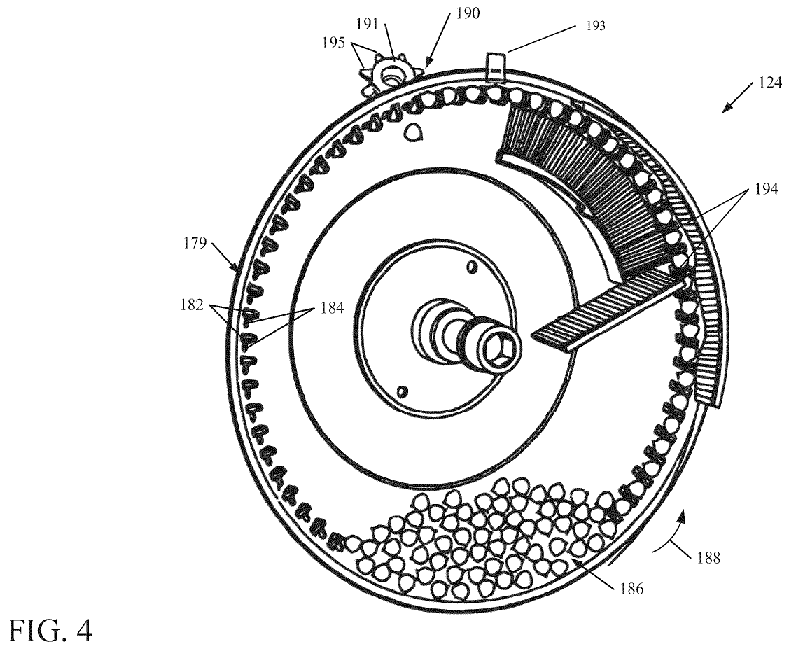

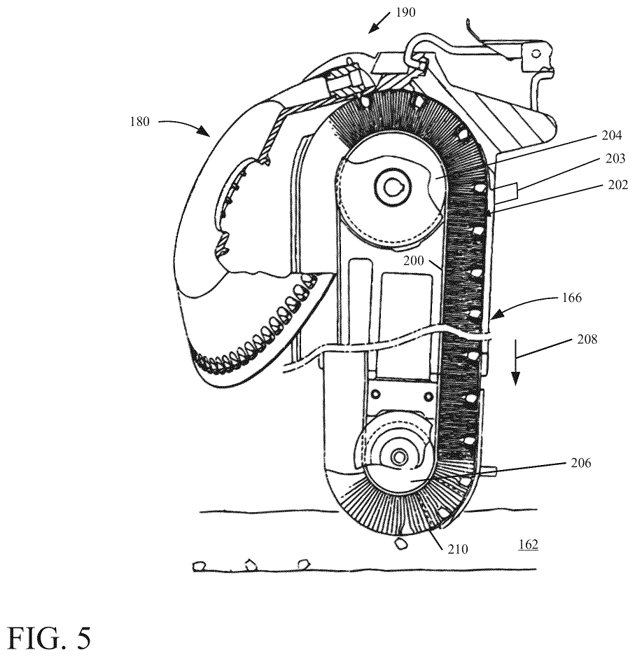

Some parts of the row unit 106 will now be discussed in more detail. First, it will be noted that there are different types of seed meters 124, and the one that is shown is shown for the sake of example only and is described in greater detail below with respect to FIG. 4. For instance, in one example, each row unit 106 need not have its own seed meter. Instead, metering or other singulation or seed dividing techniques can be performed at a central location, for groups of row units 106. The metering systems can include rotatable disks, rotatable concave or bowl-shaped devices, among others. The seed delivery system can be a gravity drop system (such as seed tube 120 shown in FIG. 2) in which seeds are dropped through the seed tube 120 and fall (via gravitational force) through the seed tube and out the outlet end 121 into the furrow (or seed trench) 162. Other types of seed delivery systems are assistive systems, in that they do not simply rely on gravity to move the seed from the metering system into the ground. Instead, such systems actively capture the seeds from the seed meter and physically move the seeds from the meter to a lower opening where the seeds exit into the ground or trench. Some examples of these assistive systems are described in greater detail below with respect to FIGS. 3 and 5.

A downforce generator or actuator 126 is mounted on a coupling assembly 128 that couples row unit 106 to toolbar 102. Downforce actuator 126 can be a hydraulic actuator, a pneumatic actuator, an electromechanical actuator, a spring-based mechanical actuator or a wide variety of other actuators. In the example shown in FIG. 2, a rod 130 is coupled to a parallel linkage 132 and is used to exert an additional downforce (in the direction indicated by arrow 134) on row unit 106. The total downforce (which includes the force indicated by arrow 134 exerted by actuator 126, plus the force due to gravity acting on the row unit 106, and indicated by arrow 136) is offset by upwardly directed forces acting on closing wheels 118 (from ground 138 and indicated by arrow 140) and double disk opener 114 (again from ground 138 and indicated by arrow 142). The remaining force (the sum of the force vectors indicated by arrows 134 and 136, minus the force indicated by arrows 140 and 142) and the force on any other ground engaging component on the row unit (not shown), is the differential force indicated by arrow 147. The differential force may also be referred to herein as downforce margin. The force indicated by arrow 147 acts on the gauge wheels 116. This load can be sensed by a gauge wheel load sensor 135 which may located anywhere on row unit 106 where it can sense that load. It can also be placed where it may not sense the load directly, but a characteristic indicative of that load. For example, it can be disposed near a set of gauge wheel control arms (or gauge wheel arm) 148 that movably mount gauge wheels to shank 152 and control an offset between gauge wheels 116 and the disks in double disk opener 114 to control planting depth. Percent ground contact is a measure of a percentage of time that the load (downforce margin) on the gauge wheels 116 is zero (indicating that the gauge wheels are out of contact with the ground). The percent ground contact is calculated on the basis of sensor data provided by the gauge wheel load sensor 135. In one example, the gauge wheel load sensor 135 is in the form of a load sensor pin that couples the control arms 148 to the shank 152 at pivot point 156. In another example, gauge wheel load sensor 135 is incorporated in mechanical stop (or arm contact member or wedge) 150.

In addition, there may be other separate and controllable downforce actuators, such as one or more of a closing wheel downforce actuator 153 that controls the downforce exerted on closing wheels 118. Closing wheel downforce actuator 153 can be a hydraulic actuator, a pneumatic actuator, an electrical actuator, a spring-based mechanical actuator or a wide variety of other actuators. The downforce exerted by closing wheel downforce actuator 153 is represented by arrow 137. It will be understood that each row unit 106 can include the various components described with reference to FIGS. 2-6.

In the illustrated example, arms (or gauge wheel arms) 148 illustratively abut a mechanical stop (or arm contact member or wedge) 150. The position of mechanical stop 150 relative to shank 152 can be set by a planting depth actuator assembly 154. Planting depth actuator assembly 154 can include a hydraulic actuator, a pneumatic actuator, an electrical actuator, or various other types of controllable actuators. Control arms 148 illustratively pivot around pivot point 156 so that, as planting depth actuator assembly 154 actuates to change the position of mechanical stop 150, the relative position of gauge wheels 116, relative to the double disk opener 114, changes, to change the depth at which seeds are planted. Additionally, row unit 106 can include a depth sensor 157, such a potentiometer, hall effect sensor, or other suitable sensor, that detects a displacement of control arms 148 to indicate the position of gauge wheels 116 and thus the operating depth of double disk opener.

In operation, row unit 106 travels generally in the direction indicated by arrow 160. The double disk opener 114 opens the furrow 162 in the soil 138, and the depth of the furrow 162 is set by planting depth actuator assembly 154, which, itself, controls the offset between the lowest parts of gauge wheels 116 and disk opener 114. Seeds are dropped through seed tube 120 into the furrow 162 and closing wheels 118 close the soil.

As the seeds are dropped through seed tube 120, they can be sensed by seed sensor 122. Some examples of seed sensor 122 are an optical sensor or a reflective sensor, and can include a radiation transmitter and a receiver. The transmitter emits electromagnetic radiation and the receiver the detects the radiation and generates a signal indicative of the presences or absences of a seed adjacent to the sensor. These are just some examples of seed sensors. Row unit 106 also includes sensor system 119 that can be used in addition to, or instead of, seed sensor 122. Sensor system 119 performs furrow sensing, including in-furrow seed sensing.

In addition to seed sensors, furrow sensors, and observation sensor systems, the individual row units 106 can include a wide variety of different types of in-situ sensors, some examples of which are illustrated in FIG. 2. For instance, row unit 106 can include a ride quality sensor 131, such as an accelerometer that senses acceleration (bouncing) of row unit 106 (or planting implement 101). In the example shown in FIG. 2, accelerometer 131 is shown mounted to shank 152. This is only an example. In other examples, accelerometer 131 can be mounted in other places as well, such as on toolbar 102 or frame 104. In some examples, accelerometer 131 can be a single axis or a multi-axis (e.g., three axis) accelerometer. In some examples, accelerometer 131 is part of an inertial measurement unit which senses, in addition to acceleration of row unit 106, other characteristics such as position and orientation (e.g., pitch, roll, and yaw). For example, in-situ sensors 308 can include machine dynamics sensors 141 that sense machine dynamics characteristics (e.g., pitch, roll, and yaw) of each row unit 106 or of planting implement 101. Machine dynamics sensors 141 can include inertial measurement units, which can include, among other things (e.g., gyroscopes, magnetometers, etc.), an accelerometer, such as accelerometer 131. Thus, while ride quality sensors 131 and machine dynamics sensors 141 are shown as separate, in some examples, ride quality and machine dynamics may be sensed by the same sensor system. Additionally, machine dynamics sensors 141 are shown mounted to shank 152, in other examples, machine dynamics sensors 141 can be mounted in other places as well, such as on toolbar 102 or frame 104.

In-situ sensors 308 can also include one or more closing wheel downforce sensors 133 which can be used to detect force on closing wheels 118.

FIG. 3 is similar to FIG. 2, and similar items are similarly numbered. However, instead of the seed delivery system being a seed tube 120 which relies on gravity to move the seed to the furrow 162, the seed delivery system shown in FIG. 3 is an assistive seed delivery system 166. Assistive seed delivery system 166 also illustratively has a seed sensor 122 disposed therein. Sensor system 119 can be used in addition to, or instead of, seed sensor 122. Sensor system 119 performs furrow (or trench) sensing, which may include in-furrow (or in-trench) seed sensing. Assistive seed delivery system 166 captures the seeds as they leave seed meter 124 and moves them in a direction indicated by arrow 168 toward furrow 162. System 166 has an outlet end 170 where the seeds exit system 166 into furrow 162 where the again reach their final seed position.

In addition, FIG. 3 shows that row unit 106 can include, as a ground engaging tool, a row cleaner unit 177 which includes a row cleaner 178 (illustratively shown as one or more opposing disks) that travel in the travel path of furrow opener 114 to clean residue, debris, as well as other obstacles, from the path of furrow opener 114. Row cleaner unit 177 also includes control arm that is coupled to the one or more disks 178 and pivotally coupled to shank 152. A row cleaner actuator 183 is controllable to change a depth of engagement of row cleaner disks 178 as well as apply a downforce to row cleaner 177. Additionally, FIG. 3 shows that row unit 106 can also include a coulter 176 (e.g., coulter disk) that is removably coupled to row unit 106 by an attachment mechanism (not shown in FIG. 3). Coulter disks are often used in planting machines at fields where no or minimal tilling was performed prior to the planting operation. The coulter 176 operates to break open the soil such that the furrow opener 114 can properly engage the soil to open a quality furrow. A coulter need not be included on a row unit 106.

FIG. 4 shows one example of a rotatable mechanism that can be used as part of the seed metering system (or seed meter) 124. The rotatable mechanism includes a rotatable disc, or concave element, 179. Concave element 179 has a cover (not shown) and is rotatably mounted relative to the frame of row unit 106. Rotatable concave element 179 is driven by a motor (not shown) and has a plurality of projections or tabs 182 that are closely proximate corresponding apertures 184. A seed pool 186 is disposed generally in a lower portions of an enclosure formed by rotating concave element 179 and its corresponding cover. Rotatable concave element 179 is rotatably driven by its motor (such as an electric motor, a pneumatic motor, a hydraulic motor, etc.) for rotation generally in the direction indicated by arrow 188, about a hub. A pressure differential is introduced into the interior of the metering mechanism so that the pressure differential influences seeds from seed pool 186 to be drawn to apertures 184. For instance, a vacuum can be applied to draw the seeds from seed pool 186 so that they come to rest in apertures 184, where the vacuum holds them in place. Alternatively, a positive pressure can be introduced into the interior of the metering mechanism to create a pressure differential across apertures 184 to perform the same function.

Once a seed comes to rest in (or proximate) an aperture 184, the vacuum or positive pressure differential acts to hold the seed within the aperture 184 such that the seed is carried upwardly generally in the direction indicated by arrow 188, from seed pool 186, to a seed discharge area 190. It may happen that multiple seeds are residing in an individual seed cell. In that case, a set of brushes or other members 194 that are located closely adjacent the rotating seed cells tend to remove the multiple seeds so that only a single seed is carried by each individual cell. Additionally, a seed sensor 193 can also illustratively be mounted adjacent to rotating element 180. Seed sensor 193 detects and generates a signal indicative of seed presence.

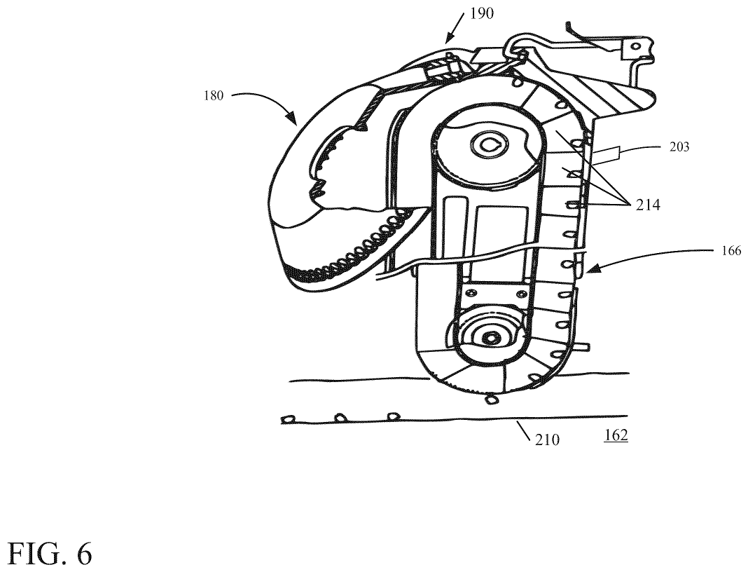

Once the seeds reach the seed discharge area 190, the vacuum or other pressure differential is illustratively removed, and a positive seed removal wheel or knock-out wheel 191, can act to remove the seed from the seed cell. Wheel 191 illustratively has a set of projections 195 that protrude at least partially into apertures 184 to actively dislodge the seed from those apertures. When the seed is dislodged (such as seed 171), it is illustratively moved by the seed tube 120, seed delivery system 166 (some examples of which are shown above in FIGS. 2-3 and below in FIGS. 5-6) to the furrow 162 in the ground.

FIG. 5 shows an example where the rotating element 180 is positioned so that its seed discharge area 190 is above, and closely proximate, assistive seed delivery system 166. In the example shown in FIG. 5, assistive seed delivery system 166 includes a transport mechanism such as a belt 200 with a brush that is formed of distally extending bristles 202 attached to belt 200 that act as a receiver for the seeds. Belt 200 is mounted about pulleys 204 and 206. One of pulleys 204 and 206 is illustratively a drive pulley while the other is illustratively an idler pulley. The drive pulley is illustratively rotatably driven by a conveyance motor (not shown), which can be an electric motor, a pneumatic motor, a hydraulic motor, etc. Belt 200 is driven generally in the direction indicated by arrow 208

Therefore, when seeds are moved by rotating element 180 to the seed discharge area 190, where they are discharged from the seed cells in rotating element 180, they are illustratively positioned within the bristles 202 by the projections 182 that push the seed into the bristles. Assistive seed delivery system 166 illustratively includes walls that form an enclosure around the bristles, so that, as the bristles move in the direction indicated by arrow 208, the seeds are carried along with them from the seed discharge area 190 of the metering mechanism, to a discharge area 210 either at ground level, or below ground level within a trench or furrow 162 that is generated by the furrow opener 114 on the row unit 106.

Additionally, a seed sensor 203 is also illustratively coupled to assistive seed delivery system 166. As the seeds are moved in bristles 202 past sensor 203, sensor 203 can detect the presence or absence of a seed. Some examples of seed sensor 203 includes an optical sensor or reflective sensor.

FIG. 6 is similar to FIG. 5, except that seed delivery system 166 is not formed by a belt with distally extending bristles. Instead, it is formed by a flighted belt (transport mechanism) in which a set of paddles 214 form individual chambers (or receivers), into which the seeds are dropped, from the seed discharge area 190 of the metering mechanism. The flighted belt moves the seeds from the seed discharge area 190 to the exit end 210 of the flighted belt, within the trench or furrow 162.

There are a wide variety of other types of seed delivery systems as well, that include a transport mechanism and a receiver that receives a seed. For instance, they include dual belt delivery systems in which opposing belts receive, hold and move seeds to the furrow, a rotatable wheel that has sprockets which catch seeds from the metering system and move them to the furrow, multiple transport wheels that operate to transport the seed to the furrow, an auger, among others.

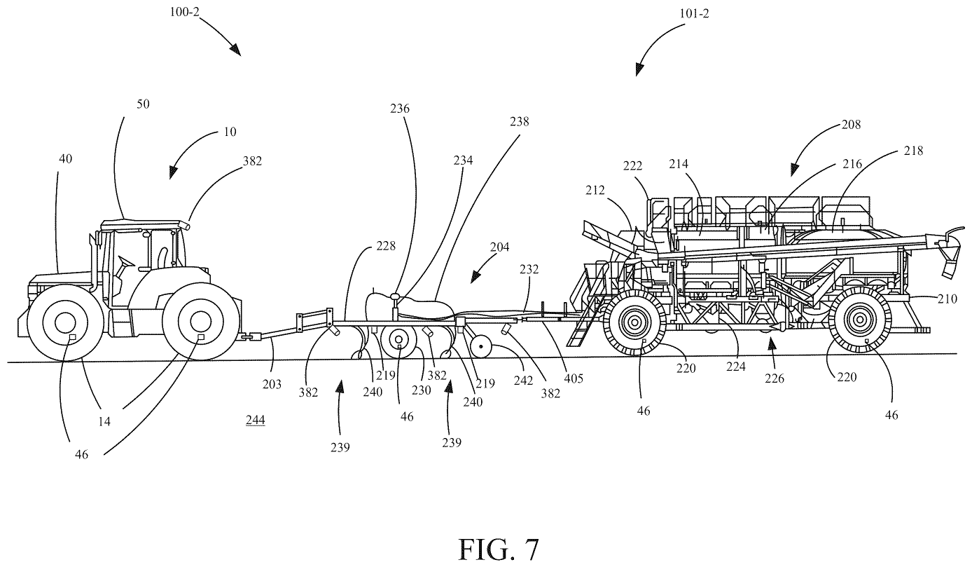

FIG. 7 is a side view showing one example of an agricultural ground engaging machine 100, as a mobile agricultural planting machine 100-2 that includes an agricultural planting implement 101-2, in the form of an air seeder (e.g., air hoe drill), and a towing vehicle. Machine 100-2 can be used in agricultural ground engaging system architecture 300. Ground engaging tool implement 101-2 is towed by a towing vehicle, such as towing vehicle 10, such as a tractor.

In the example shown in FIG. 7, the implement 101-2 comprises a tilling implement (or seeding tool) 204 (also sometimes called a drill or a hoe drill) towed between the towing vehicle 10 and a commodity cart 208 (also sometimes called an air cart). The towing vehicle 10, illustratively in the form of a tractor, includes a propulsion subsystem 40 (such as an internal combustion engine or other power plant, and associated drivetrain components) an operator compartment (or cab) 50) and a set of wheels 14 including tires (though in other examples, towing vehicle could include track systems).

The commodity cart 208 has a frame 210 upon which a series of product tanks 212, 214, 216, and 218, and wheels 220 are mounted. Each product tank has a door (a representative door 222 is labeled) releasably sealing an opening at its upper end for filling the tank with product, most usually a commodity of one type or another. A metering system 224 is provided at a lower end of each tank (a representative one of which is labeled) for controlled feeding or draining of product (most typically granular material) into a pneumatic distribution system 226. The tanks 212, 214, 216, and 218 can hold, for example, a material or commodity such as seed or fertilizer, or both, to be distributed to the soil. The tanks can be hoppers, bins, boxes, containers, etc. The term “tank” shall be broadly construed herein. Furthermore, one tank with multiple compartments can also be provided instead of separated tanks.

The tilling implement or seeding tool 204 includes a frame 228 supported by ground wheels 230 which include tires. Frame 228 is connected to a leading portion of the commodity cart 208, for example by a tongue style attachment (not labeled). The commodity cart 208 as shown is sometimes called a “tow behind cart,” meaning that the cart 208 follows the seeding tool 204. In an alternative arrangement, the cart 208 can be configured as a “tow between cart,” meaning the cart 208 is between the towing vehicle 10 and seeding tool 204. In yet a further possible arrangement, the commodity cart 208 and tilling implement 204 can be combined to form a unified rather than separated configuration. These are just examples of additional possible configurations. Other configurations are even possible and all configurations should be considered contemplated and within the scope of the present description.

In the example shown in FIG. 7, towing vehicle 10 is coupled by couplings 203 to seeding tool 204 which is coupled by couplings 205 to commodity cart 408. The couplings 203 and 205 can be mechanical, hydraulic, pneumatic, and electrical couplings and/or other couplings. The couplings 203 and 205 can include wired and wireless couplings as well.

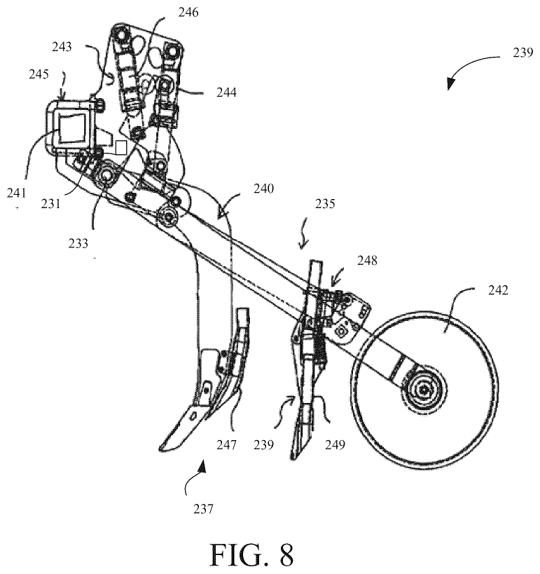

The pneumatic distribution system 226 includes a fan (not shown) connected to a product delivery conduit structure having multiple product flow passages 232. The fan directs air through the flow passages 232. Each product metering system 224 controls delivery of product from its associated tank at a controllable rate to the transporting airstreams moving through flow passages 232. In this manner, each flow passage 232 carries product from the tanks to a secondary distribution tower 234 on the seeding tool 204. Typically, there will be one tower 234 for each flow passage 232. Each tower 234 includes a secondary distributing manifold 236, typically located at the top of a vertical tube. The distributing manifold 236 divides the flow of product into a number of secondary distribution lines 438. Each secondary distribution line 438 delivers product to one of a plurality of row units 239. Each row unit 239 includes, among other things, as ground engaging tools, ground openers 240 (also known as furrow openers, illustratively in the form of shanks) as well as closing (or packing wheels) 242. An example of a row unit 239 will be shown in greater detail in FIG. 8. The ground opening tools 240 open a furrow in the soil 244 and facilitates deposit of the product therein. The number of flow passages 232 that feed into secondary distribution may vary from one to eight or ten or more, depending at least upon the configuration of the commodity cart 208 and seeing tool 204. Depending upon the cart and seeding tool, there may be two distribution manifolds 236 in the air stream between the meters 224 and the ground opening tools 240. Alternatively, in some configurations, the product is metered directly from the tank or tanks into secondary distribution lines that lead to the ground opening tools 240 without any need for an intermediate distribution manifold. The product metering system 224 can be configured to vary the rate of delivery of seed to each work point on tool 204 or to different sets or zones of work points on tool 204. The configurations described herein are only examples. Other configurations are possible and should be considered contemplated and within the scope of the present description.

A packing or closing wheel 242 is associated with each ground opening tool 240 trails the tool 240 and closes or packs the soil over the product deposited in the soil. The tools 240 are typically moveable between a lowered position engaging the ground and a raised position riding above the ground. Each individual tool 240 may be configured to be raised by a separate actuator. Alternatively, multiple tools 240 may be mounted to a common component for movement together. In yet another alternative, the tools 240 may be fixed to the frame 228, the frame being configured to be raised and lowered with the tools 240, such as by controllable actuation of an actuator that raises and lowers wheels 230.

It should be noted that the mobile ground engaging machine 100 as illustrated in FIG. 7 can include a variety of in-situ sensors 308, some examples of which are shown in FIG. 7. For example, FIG. 7 shows that ground engaging machine 100 can include one or more one or more machine speed sensors 46 that sense the travel speed of mobile ground engaging machine 100 over the ground. Machine speed sensors 46 may sense the travel speed of the mobile ground engaging machine 100 by sensing the speed of rotation of the ground engaging components (such as 14, 230, or 220), a drive shaft, an axel, or other components. In some instances, the travel speed may be sensed using a positioning system, such as geographic position sensors (e.g., 304 shown in FIG. 10), a global positioning system (GPS), a dead reckoning system, a long range navigation (LORAN) system, or a wide variety of other systems or sensors that provide an indication of travel speed.

FIG. 7 also shows that each ground opening tool 240 can have an associated sensor system 219. Sensor systems 219 can be coupled to various locations across frame 228 or to another portion of seeding tool 204. Sensor system 219 detects characteristics of the furrow (or trench) opened by the respective ground opening tool, including, but not limited to, the depth of the furrow (or trench). In one example, sensor system 219 is an observation sensor system that includes one or more sensors, such as one or more imaging systems (e.g., stereo or mono cameras), optical sensors, lidar, radar, ultrasonic sensors, as well as various other types of sensors.

FIG. 7 also shows that machine 100-2 can include one or more observation sensor systems 382 that detect material flow issues, such as accumulation of material on tools and plugging of tools or plugging of a tool assembly (e.g., row unit plugging). Observation sensor systems 382 can include one or more sensors, such as one or more imaging systems (e.g., mono or stereo cameras), optical sensors, radar, lidar, ultrasonic sensors, thermal or infrared sensors, acoustic or vibration sensors that detect noise or vibration of the ground engaging tools, as well as various other sensors, such as sensors that emit and/or receive electromagnetic radiation. In some examples, observation sensor systems 382 can detect the tools directly, such as to detect accumulated material on the tools and to detect plugging of the tools. In other examples, observation sensor systems 382 may detect other characteristics indicative of material accumulation or plugging, such as pushing of material, scraping of the soil behind the tools, poor tillage bed quality, movement (or lack thereof) of material around the tools, clumps of material behind the tool, as well as various other characteristics. Thus, it will be understood that observation sensor systems 382 can detect or have a field of view that includes ground around the tools or the tools themselves, or both. Additionally, while the example shown in FIG. 7 illustrates observation sensor systems 382 being disposed at various different locations, in other examples, the observation sensor systems 382 can be disposed, alternatively or additionally, on other parts of implement 101-2 or on other parts of machine 100-2. Further, and as will be discussed in more detail in FIG. 10, machine 100 can include other types of material flow issue sensors 380, such as control input sensors 384.

In some examples, sensor system 219 may also detect material flow issues, such as accumulation or plugging.

FIG. 8 is a perspective view showing one example of a row unit 239 in more detail. As illustrated in FIG. 8, row unit 239 include ground opening tool 240 and closing or packing wheel 242. FIG. 8 shows that row unit 239 is coupled to bracket 243 which is coupled to a toolbar 241, by suitable coupling mechanisms 245 (such as U-shaped clamping bolts). Toolbar 241 is attached to (or forms part of) frame 228, and has a longitudinal axis that is transverse to the longitudinal axis of frame 228. Row unit includes a first material delivery member 237 that includes a tube 247 and a second material delivery member 239 that includes a tube 249 and a mounting system 248. In some examples, the tube 247 delivers a first material (such as fertilizer) and the tube 249 delivers a second material (such as seed). The tubes 247 and 249 can be laterally and vertically offset such that the first and second materials are placed at different depths and different lateral positions in the furrow (or trench).

Ground opening tool 240 is pivotally coupled to the bracket 245 at pivot point 233. Closing wheel is coupled to an end of control arm 235. The other end of control arm 235 is pivotally coupled to pivot point 233. A ground opening tool actuator 244 actuates ground opening tool 240 and can apply a downforce against ground opening tool 240. A closing or packing wheel actuator 246 actuates closing or packing wheel 242 (via control arm 235) and can apply a downforce against closing or packing wheel 242.

As illustrated in FIG. 8, row unit 239 can include one or more sensors 231 that sense that displacement of ground opening tool 240 or control arm 235, or both, and thus indicate a working depth of ground opening tool 240 or closing or packing wheel 242, or both.

While the examples shown in FIGS. 7-9 show a planting implement 101 in the form of an air hoe drill 101-2, it will be understood that various other planting implements, such as various other air seeding planting implements (such as a no-till air drill) are also contemplated.

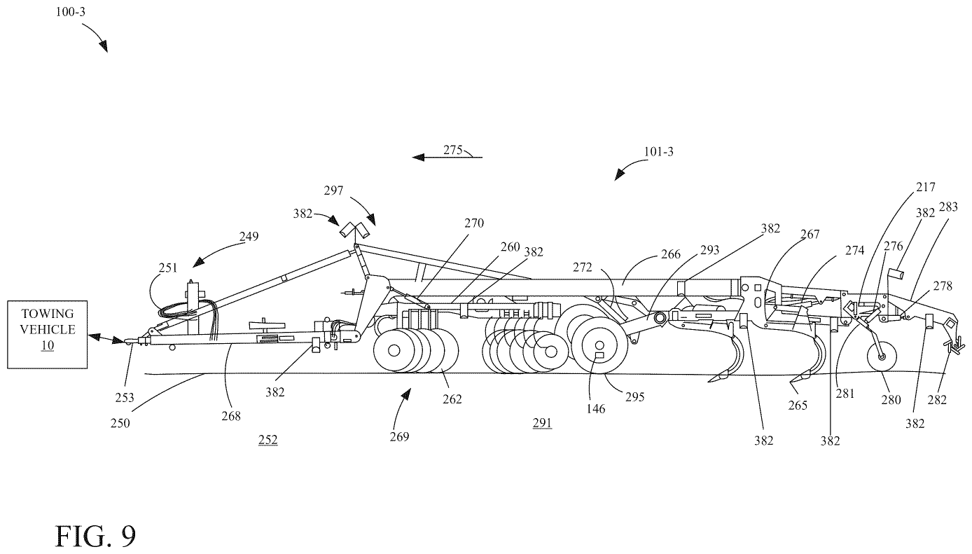

FIG. 9 is a partial side view, partial block diagram showing one example of a mobile agricultural ground engaging machine 100, in the form of a mobile tillage machine 100-3, that includes a ground engaging tool implement 101 in the form of a tillage implement 101-3 and a towing vehicle 10. As shown tillage implement 101-3 is towed by towing vehicle 10 in the direction indicated by arrow 275 and operates at a field 291. Tillage implement 101-3 includes a plurality of tools that can engage the surface 250 of the ground 291 or penetrate the sub-surface 252 of the ground 292. As illustrated, tillage implement 101-3 may include, as tools, forward disks 262 (which form a disk gang 269), shanks 265, rearward disks 280, and roller basket 282. In other examples, tillage implement 101-3 can include various other kinds of tools, such as tines. As illustrated, implement 101-3 may include a connection assembly 249 for coupling to the towing vehicle 10. Connection assembly that includes a mechanical connection mechanism 253 (shown as a hitch) as well as a connection harness 251 which may include a plurality of different connection lines, which may provide, among other things, power, fluid (e.g., hydraulics or air, or both), as well as communication. In some examples, implement 101-3 may include its own power and fluid sources. The connection lines of connection harness 251 may form a conduit for delivering power and/or fluid to the various actuators on implement 101-3.

As illustrated in FIG. 9, implement 101-3 can include a plurality of actuators. Actuators 270 are coupled between subframe 260 and main frame 266 and are controllably actuatable to change a position of the subframe 260 relative to the main frame 266 in order to change a position of the disks 262 relative to the main frame 266 as well as to apply a downforce to the disks 262.

Actuators 272 are coupled between a wheel frame 293 and main frame 266 and are controllably actuatable to change a position of the wheels 295 relative to the main frame 266 and thus change a distance between main frame 266 and the surface 250 of the field 291 as well as to apply a downforce to the wheels 295. Thus, actuators 272 can be used to control the depth of the various tools of implement 101-3. Additionally, each wheel 295 can include a respective actuator 272 that is separately controllable such that the implement 101-3 can be leveled across its width. For instance, where the ground near a left wheel 295 is lower than the ground by a right wheel, the left wheel can be extended farther, by controllably actuating a respective actuator 272, than the right wheel 295 to level the implement 101-3 across its width. Additionally, a tillage implement 101-3 may include a plurality of wheels 295 across both its width and across its fore-to-aft length such that both side-to-side leveling and fore-to-aft (e.g., front-to-back, or vice versa) leveling can be achieved by variably controlling the separate wheels. These additional wheels can be coupled to the main frame or to subframes such that wing leveling can also occur.

As shown, hinge or pivot assembly 297 allows for movement of main frame 266 relative to hitch frame 268.

Actuators 274 are coupled between tool frame 267 and main frame 266 and are controllably actuatable to change a position of tools 265 as well as to apply a downforce to tools 265. While tools 265 are shown as ripper shanks, in other examples a tillage implement 101 may include other tools, alternatively or in addition to ripper shanks 265, such as tines.

Actuators 276 are coupled between tool frame 281 and main frame 266 and are controllably actuatable to change a position of tools 280 as well as to apply a downforce to tools 280. While tools 280 are shown as disks, in other examples a tillage implement 101-3 may include other tools, alternatively or in addition to disks 280, such as tines.

Actuators 278 are coupled between tool frame 283 and main frame 266 and are actuatable to change a position of tools 282 as well as apply a downforce to tools 282. Tools 282 are illustratively roller baskets.

As illustrated in FIG. 9, machine 100-3 can include one or more material flow issue sensors 380 that detect material flow issues, such as accumulation of material on tools or tool assemblies and plugging of tools or tool assemblies. As shown in FIG. 9, machine 100-3 can include, as material flow issue sensors 380, one or more observation sensors systems 382. Observation sensor systems 382 can include one or more sensors, such as one or more imaging systems (e.g., mono or stereo cameras), optical sensors, radar, lidar, thermal or infrared sensors, acoustic or vibration sensors that detect noise or vibration of the ground engaging tools, as well as various other sensors, such as sensors that emit and/or receive electromagnetic radiation. In some examples, observation sensor systems 382 can detect the tools directly, such as to detect accumulated material on the tools and to detect plugging of the tools. In some examples, the tools may be assembled in a gang, such that material can plug the space between the individual tools of the gang. Material may also accumulate on the individual tools themselves. In some examples, certain tools, like roller baskets, may have space between components in which material may become plugged. In other examples, observation sensor systems 382 may detects other characteristics indicative of material accumulation or plugging, such as pushing of material, scraping of the soil behind the tools, poor tillage bed quality, movement (or lack thereof) of material around the tools, clumps of material behind the tool, as well as various other characteristics. Thus, it will be understood that observation sensor systems 382 can detect or have a field of view that includes ground around the tools or the tools themselves, or both. Additionally, while the example shown in FIG. 9 illustrates observation sensor systems 382 being disposed on implement 101-3, in other examples, one or more observation sensors systems 382 can be disposed on towing vehicle 10, alternatively or in addition to, observation sensor systems 382 on implement 101-3. Further, and as will be discussed in more detail in FIG. 10, machine 100 can include other types of material flow issue sensors 380, such as control input sensors 384.

FIG. 10 is a block diagram showing some portions of an agricultural ground engaging system architecture 300. FIG. 10 shows that agricultural system architecture 300 includes mobile agricultural ground engaging machine 100, such as machine 100-1, which may include a towing vehicle 10 and implement 101-1, machine 100-2, which may include a towing vehicle 10 and implement 101-2, or machine 100-3, which may include a towing vehicle 10 and implement 101-3. In other examples, mobile agricultural ground engaging machine 100 may be a different type of mobile agricultural ground engaging machine. Agricultural system 300 also includes one or more remote computing systems 368, one or more remote user interfaces 364, network 359, and one or more information maps 358. Mobile ground engaging machine 100, itself, illustratively includes one or more processors or servers 301, data store 302, geographic position sensor 304, communication system 306, one or more in-situ sensors 308 that sense one or more characteristics of at field concurrent with an operation, and a processing system 338 that processes the sensor data (e.g., sensor signals, images, etc.) generated by in-situ sensors 308 to generate processed sensor data. The in-situ sensors 308 generate values corresponding to the sensed characteristics. Mobile machine 100 also includes a predictive model or relationship generator (collectively referred to hereinafter as “predictive model generator 310”), predictive model or relationship (collectively referred to hereinafter as “predictive model 311”), predictive map generator 312, control zone generator 313, control system 314, one or more controllable subsystems 316, and an operator interface mechanism 318. The mobile machine can also include a wide variety of other machine functionality 320.

The in-situ sensors 308 can be on-board mobile machine 100, remote from mobile machine, such as deployed at fixed locations on the worksite or on another machine operating in concert with mobile machine 100, such as an aerial vehicle, and other types of sensors, or a combination thereof. In-situ sensors 308 sense characteristics at the worksite during the course of an operation. In-situ sensors 308 illustratively include material flow issue sensors 380, heading/speed sensors 325, and can include various other sensors 328, such as the various other sensors described in FIGS. 1-9. Material flow issue sensors 380 themselves include one or more observation sensor systems 382, one or more control input sensors 384, and can include various other sensors 386.

Material flow issue sensors 380 provide sensor data indicative of material flow issues, such as material accumulation on tools or tool assemblies (e.g., row units, tool gang, etc.) or plugging of tools or tool assemblies.

Observation sensor systems 382 observe tools or tool assemblies or area around the tools or tool assemblies, or both, and provide sensor data indicative of material flow issues. Observation sensor systems 382 can include one or more sensors, such as one or more imaging systems (e.g., mono or stereo cameras), optical sensors, radar, lidar, thermal or infrared sensors, acoustic or vibration sensors that detect noise or vibration of the ground engaging tools, as well as various other sensors, such as sensors that emit and/or receive electromagnetic radiation. In some examples, observation sensor systems 382 can detect the tools directly, such as to detect accumulated material on the tools and to detect plugging of the tools. In other examples, observation sensor systems 382 may detects other characteristics indicative of material accumulation or plugging, such as pushing of material, scraping of the soil behind the tools, poor job quality (e.g., poor tillage quality, poor furrow closing quality, poor furrow opening quality, etc.), movement (or lack thereof) of material around the tools, clumps of material behind the tool, as well as various other characteristics. Thus, it will be understood that observation sensor systems 382 can detect or have a field of view that includes ground around the tools or the tools themselves, or both. Additionally, the one or more observation sensor systems 382 can be placed at various locations on machine 100, such as on one or both of towing vehicle 10 and implement 101.

Control input sensors 384 detect material flow issue control inputs and provide sensor data indicative of material flow issues. Control inputs are inputs provided for the control of machine 100. Control inputs may be provided by an operator 360, such as through an operator interface mechanism 318, by a user 366, such as through a user interface mechanism 366, or by control system 314. Material flow issue control inputs are control inputs that may be provided in response to material flow issues, and thus, are indicative of material flow issues. For example, material flow issue control inputs may include control inputs that cause the machine to pass over the same location twice. For instance, the tillage quality for an area that has been operated on may be poor, due to material flow issues, in which case a control input may be provided to cause the machine 100 to travel over and till the area again. In another example, material flow issue control inputs may include control inputs, such as control input that cause the tools to raise out of engagement with the ground or control inputs that cause the tools or tool assemblies to rise up and down, repeatedly, and in quick fashion, such as in an attempt to “shake” off accumulated material. Other material issue control inputs may include control inputs that slow the machine down, change tool positions (e.g., tool height or depth, tool angles), control inputs that adjust a downforce, as well as various other control inputs.

In some examples, material flow issue sensors 380 can include other types of material flow sensors 386 or can utilize sensor data from other sensors. For instance, material flow issue sensors 380 can include speed sensors that detect a speed of mobile machine 100 or utilize senor data from other sensors (e.g., heading/speed sensors 325) that indicate a speed of the mobile machine 100. A slowing of the machine 100 or the machine 100 being brought to a stop may be indicative of material accumulation or plugging due to the additional drag caused by material accumulation or plugging. This is merely one example.

Thus, material flow issue sensors 380 detect characteristics indicative of material flow issues and generate sensor data indicative of material flow issue values. Material flow issue values can be indicative of accumulation of material on tools or tool assemblies or plugging of tools or tool assemblies, or both.

Operating parameter sensors 370 provide sensor data indicative of operating parameters of mobile agricultural ground engaging machine 100. Operating parameter sensors 370 can detect such parameters as tool positions (e.g., tool depth, tool angle, etc.), applied downforce, as well as various other operating parameters. Operating parameter sensors 370 can include a wide variety of different types of sensors, including, for example, the sensor described above with respect to FIGS. 1-9.

Geographic position sensors 304 illustratively sense or detect the geographic position or location of mobile ground engaging machine 100. Geographic position sensors 304 can include, but are not limited to, a global navigation satellite system (GNSS) receiver that receives signals from a GNSS satellite transmitter. Geographic position sensors 304 can also include a real-time kinematic (RTK) component that is configured to enhance the precision of position data derived from the GNSS signal. Geographic position sensors 304 can include a dead reckoning system, a cellular triangulation system, or any of a variety of other geographic position sensors. Geographic positions sensors 304 can be on towing vehicle 10 or planting implement 101, or both.

Heading/speed sensors 325 detect a heading and speed at which mobile machine 100 is traversing the worksite during the operation. This can include sensors that sense the movement of ground-engaging elements (e.g., wheels or tracks of towing vehicle 10 or implement 101, or both), such as sensors 146, or can utilize signals received from other sources, such as geographic position sensor 304, thus, while heading/speed sensors 325 as described herein are shown as separate from geographic position sensor 304, in some examples, machine heading/speed is derived from signals received from geographic positions sensor 304 and subsequent processing. In other examples, heading/speed sensors 325 are separate sensors and do not utilize signals received from other sources.

Other in-situ sensors 328 may be any of the sensors described above with respect to FIGS. 1-9. Other in-situ sensors 328 can be on-board mobile machine 100 or can be remote from mobile machine 100, such as other in-situ sensors 328 on-board another mobile machine that capture in-situ data of characteristics at the field or sensors at fixed locations throughout the field. The remote data from remote sensors can be obtained by mobile machine 100 via communication system 306 over network 359.

In-situ data includes data taken from a sensor on-board the mobile ground engaging machine 100 or taken by any sensor where the data are detected during the operation of mobile ground engaging machine 100 at a field.

Processing system 338 processes the sensor data (e.g., signals, images, etc.) generated by in-situ sensors 308 to generate processed sensor data indicative of one or more characteristics. For example, processing system generates processed sensor data indicative of characteristic values based on the sensor data generated by in-situ sensors 308, such as material flow issue values (e.g., material accumulation values, plugging values, etc.) based on sensor data generated by material flow issue sensors 380. Processing system 338 also processes sensor signals generated by other in-situ sensors 308 to generate processed sensor data indicative of other characteristic values, such as operating parameter values based on sensor data generated by operating parameter sensors 370, machine speed characteristic (travel speed, acceleration, deceleration, etc.) values based on sensor data generated by heading/speed sensors 325, machine heading values based on sensor data generated by heading/speed sensors 325, geographic position (or location) values based on sensor data generated by geographic position sensors 304, as well as various other values based on sensors signals generated by various other in-situ sensors 328.

It will be understood that processing system 338 can be implemented by one or more processers or servers, such as processors or servers 301. Additionally, processing system 338 can utilize various sensor signal filtering techniques, noise filtering techniques, sensor signal categorization, aggregation, normalization, as well as various other processing functionalities. Similarly, processing system 338 can utilize various image processing techniques such as, sequential image comparison, RGB, edge detection, black/white analysis, machine learning, neural networks, pixel testing, pixel clustering, shape detection, as well any number of other suitable image processing and data extraction functionalities.

FIG. 10 also shows remote users 366 interacting with mobile machine 100 or remote computing systems 368, or both, through user interfaces mechanisms 364 over network 359. In some examples, user interface mechanisms 364 may include joysticks, levers, a steering wheel, linkages, pedals, buttons, dials, keypads, user actuatable elements (such as icons, buttons, etc.) on a user interface display device, a microphone and speaker (where speech recognition and speech synthesis are provided), among a wide variety of other types of control devices. Where a touch sensitive display system is provided, user 366 may interact with user interface mechanisms 364 using touch gestures. These examples described above are provided as illustrative examples and are not intended to limit the scope of the present disclosure. Consequently, other types of user interface mechanisms 364 may be used and are within the scope of the present disclosure.

Remote computing systems 368 can be a wide variety of different types of systems, or combinations thereof. For example, remote computing systems 368 can be in a remote server environment. Further, remote computing systems 368 can be remote computing systems, such as mobile devices, a remote network, a farm manager system, a vendor system, or a wide variety of other remote systems. In one example, mobile machine 100 can be controlled remotely by remote computing systems or by remote users 366, or both. As will be described below, in some examples, one or more of the components shown being disposed on mobile machine 100 in FIG. 10 can be located elsewhere, such as at remote computing systems 368.

FIG. 10 also shows that an operator 360 may operate mobile machine 100. The operator 360 interacts with operator interface mechanisms 318. In some examples, operator interface mechanisms 318 may include joysticks, levers, a steering wheel, linkages, pedals, buttons, dials, keypads, user actuatable elements (such as icons, buttons, etc.) on a user interface display device, a microphone and speaker (where speech recognition and speech synthesis are provided), among a wide variety of other types of control devices. Where a touch sensitive display system is provided, operator 360 may interact with operator interface mechanisms 318 using touch gestures. In some examples, at least some operator interface mechanisms 318 may be disposed in an operator compartment of mobile ground engaging machine 100 (e.g., 50). In some examples, at least some operator interface mechanisms 318 may be remote (or separable) from mobile ground engaging machine 100 but are in communication therewith. Thus, the operator 360 may be local or remote. These examples described above are provided as illustrative examples and are not intended to limit the scope of the present disclosure. Consequently, other types of operator interface mechanisms 318 may be used and are within the scope of the present disclosure.

FIG. 10 also shows that mobile machine 100 can obtain one or more information maps 358. As described herein, the information maps 358 include, for example, a topographic map, a residue moisture/toughness map, a soil moisture map, a soil type map, a vegetative index (VI) map, an optical map, a prior operation map, such as a prior harvesting operation map or a prior tillage operation map, or both, a historical yield map, a weed map, as well as various other maps. However, information maps 358 may also encompass other types of data, such as other types of data that were obtained prior to a current operation or a map from a prior operation. In other examples, information maps 358 can be generated during a current operation, such a map generated by predictive map generator 312 based on a predictive model 311 generated by predictive model generator 310.

Information maps 358 may be downloaded onto mobile ground engaging machine 100 over network 359 and stored in data store 302, using communication system 306 or in other ways. In some examples, communication system 306 may be a cellular communication system, a system for communicating over a wide area network or a local area network, a system for communicating over a near field communication network, or a communication system configured to communicate over any of a variety of other networks or combinations of networks. Network 264 illustratively represents any or a combination of any of the variety of networks. Communication system 306 may also include a system that facilitates downloads or transfers of information to and from a secure digital (SD) card or a universal serial bus (USB) card or both.

Predictive model generator 310 generates a predictive model 311 that is indicative of a relationship between the values sensed by the in-situ sensors 308 and values mapped to the field by the information maps 358. For example, if the information map 358 maps topographic values to different locations in the worksite, and the in-situ sensor 308 are sensing values indicative of material flow issues, then model generator 310 generates a predictive material flow issue model that models the relationship between the topographic values and the material flow issue values. In another example, if the information map 358 maps soil type values to different locations in the worksite, and the in-situ sensors 308 are sensing values indicative of material flow issues, then model generator 310 generates a predictive material flow issue model that models the relationship between the soil type values and the material flow issue values. These are merely some examples.

In some examples, the predictive map generator 312 uses the predictive models generated by predictive model generator 310 to generate functional predictive maps that predict the value of a characteristic, sensed by the in-situ sensors 308, at different locations in the field based upon one or more of the information maps 358.

For example, where the predictive model is a predictive material flow issue model that models a relationship between material flow issue values sensed by in-situ sensors 308 and one or more of topographic values from a topographic map, residue moisture/toughness values from a residue moisture/toughness map, soil moisture values from a soil moisture map, soil type values from a soil type map, vegetative index values from a vegetative index map, optical characteristic values from an optical map, prior harvesting operation characteristic values from a prior harvesting operation map, prior tillage operation characteristic values from a prior tillage operation map, historical yield values from a historical yield map, wee values from a weed map, and other characteristic values from an other map, then predictive map generator 312 generates a functional predictive material flow issue map that predicts material flow issue values at different locations at the worksite based on one or more of the mapped values at those locations and the predictive material flow issue model.

In some examples, the type of values in the functional predictive map 263 may be the same as the in-situ data type sensed by the in-situ sensors 308. In some instances, the type of values in the functional predictive map 263 may have different units from the data sensed by the in-situ sensors 308. In some examples, the type of values in the functional predictive map 263 may be different from the data type sensed by the in-situ sensors 308 but have a relationship to the type of data type sensed by the in-situ sensors 308. For example, in some examples, the data type sensed by the in-situ sensors 308 may be indicative of the type of values in the functional predictive map 363. In some examples, the type of data in the functional predictive map 363 may be different than the data type in the information maps 358. In some instances, the type of data in the functional predictive map 263 may have different units from the data in the information maps 358. In some examples, the type of data in the functional predictive map 263 may be different from the data type in the information map 358 but has a relationship to the data type in the information map 358. For example, in some examples, the data type in the information maps 358 may be indicative of the type of data in the functional predictive map 263. In some examples, the type of data in the functional predictive map 263 is different than one of, or both of, the in-situ data type sensed by the in-situ sensors 308 and the data type in the information maps 358. In some examples, the type of data in the functional predictive map 263 is the same as one of, or both of, of the in-situ data type sensed by the in-situ sensors 308 and the data type in information maps 358. In some examples, the type of data in the functional predictive map 263 is the same as one of the in-situ data type sensed by the in-situ sensors 308 or the data type in the information maps 358, and different than the other.

As shown in FIG. 10, predictive map 264 predicts the value of a sensed characteristic (sensed by in-situ sensors 308), or a characteristic related to the sensed characteristic, at various locations across the worksite based upon one or more information values in one or more information maps 358 at those locations and using the predictive model 311. For example, if predictive model generator 310 has generated a predictive model indicative of a relationship between soil moisture values and material flow issue values then, given the soil moisture value at different locations across the worksite, predictive map generator 312 generates a predictive map 264 that predicts material flow issue values at different locations across the worksite. The soil moisture value, obtained from the soil moisture map, at those locations and the relationship between soil moisture values and material flow issue values, obtained from the predictive model 311, are used to generate the predictive map 264. This is merely one example.

Some variations in the data types that are mapped in the information maps 358, the data types sensed by in-situ sensors 308, and the data types predicted on the predictive map 264 will now be described.

In some examples, the data type in one or more information maps 358 is different from the data type sensed by in-situ sensors 308, yet the data type in the predictive map 264 is the same as the data type sensed by the in-situ sensors 308. For instance, the information map 358 may be a vegetative index map, and the variable sensed by the in-situ sensors 308 may be material flow issues. The predictive map 264 may then be a predictive material flow issue map that maps predictive material flow issue values to different geographic locations in the in the worksite.

Also, in some examples, the data type in the information map 358 is different from the data type sensed by in-situ sensors 308, and the data type in the predictive map 264 is different from both the data type in the information map 358 and the data type sensed by the in-situ sensors 308.

In some examples, the information map 358 is from a prior pass through the field during a prior operation and the data type is different from the data type sensed by in-situ sensors 308, yet the data type in the predictive map 264 is the same as the data type sensed by the in-situ sensors 308. For instance, the information map 358 may be a prior operation map, such as a prior harvesting operation map or a prior tillage operation map, generated during a previous operation on the field, and the variable sensed by the in-situ sensors 308 may be material flow issues. The predictive map 264 may then be a predictive material flow issue map that maps predictive material flow issue values to different geographic locations in the field.

In some examples, the information map 358 is from a prior pass through the field during a prior operation and the data type is the same as the data type sensed by in-situ sensors 308, and the data type in the predictive map 264 is also the same as the data type sensed by the in-situ sensors 308. For instance, the information map 358 may be a material flow map generated during a previous year, and the variable sensed by the in-situ sensors 308 may be material flow issues. The predictive map 264 may then be a predictive material flow issue map that maps predictive material flow issue values to different geographic locations in the field. In such an example, the relative material flow issue differences in the georeferenced information map 358 from the prior year can be used by predictive model generator 310 to generate a predictive model that models a relationship between the relative material flow issue differences on the information map 358 and the material flow issue values sensed by in-situ sensors 308 during the current operation. The predictive model is then used by predictive map generator 310 to generate a predictive material flow issue map.

In another example, the information map 358 may be a map, such as soil moisture map, generated during a prior operation in the same year, and the variable sensed by the in-situ sensors 308 during the current operation may be material flow issues. The predictive map 264 may then be a predictive material flow issue map that maps predictive material flow issue values to different geographic locations in the field. In such an example, a map of the soil moisture values at time of the prior operation is geo-referenced, recorded, and provided to mobile machine 100 as an information map 358 of soil moisture values. In-situ sensors 308 during a current operation can detect material flow issues at geographic locations in the field and predictive model generator 310 may then build a predictive model that models a relationship between material flow issue at the time of the current operation and soil moisture values at the time of the prior operation. This is because the soil moisture values at the time of the prior operation are likely to be the same as at the time of the current planting operation or may be more accurate or otherwise may be more reliable than soil moisture values obtained in other ways. Soil moisture is merely one example.

In some examples, predictive map 264 can be provided to the control zone generator 313. Control zone generator 313 groups adjacent portions of an area into one or more control zones based on data values of predictive map 264 that are associated with those adjacent portions. A control zone may include two or more contiguous portions of a worksite, such as a field, for which a control parameter corresponding to the control zone for controlling a controllable subsystem is constant. For example, a response time to alter a setting of controllable subsystems 316 may be inadequate to satisfactorily respond to changes in values contained in a map, such as predictive map 264. In that case, control zone generator 313 parses the map and identifies control zones that are of a defined size to accommodate the response time of the controllable subsystems 316. In another example, control zones may be sized to reduce wear from excessive actuator movement resulting from continuous adjustment. In some examples, there may be a different set of control zones for each controllable subsystem 316 or for groups of controllable subsystems 316. The control zones may be added to the predictive map 264 to obtain predictive control zone map 265. Predictive control zone map 265 can thus be similar to predictive map 264 except that predictive control zone map 265 includes control zone information defining the control zones. Thus, a functional predictive map 263, as described herein, may or may not include control zones. Both predictive map 264 and predictive control zone map 265 are functional predictive maps 263. In one example, a functional predictive map 263 does not include control zones, such as predictive map 264. In another example, a functional predictive map 263 does include control zones, such as predictive control zone map 265.

It will also be appreciated that control zone generator 313 can cluster values to generate control zones and the control zones can be added to predictive control zone map 265, or a separate map, showing only the control zones that are generated. In some examples, the control zones may be used for controlling or calibrating mobile machine 100 or both. In other examples, the control zones may be presented to the operator 360 and used to control or calibrate mobile machine 100, and, in other examples, the control zones may be presented to the operator 360 or another user, such as a remote user 366, or stored for later use.

Predictive map 264 or predictive control zone map 265 or both are provided to control system 314, which generates control signals based upon the predictive map 264 or predictive control zone map 265 or both. In some examples, communication system controller 329 controls communication system 306 to communicate the predictive map 264 or predictive control zone map 265 or control signals based on the predictive map 264 or predictive control zone map 265 to other mobile machines (e.g., other mobile ground engaging machines) that are operating at the same worksite or in the same operation. In some examples, communication system controller 329 controls the communication system 306 to send the predictive map 264, predictive control zone map 265, or both to other remote systems, such as remote computing systems 368.

Control system 314 includes communication system controller 329, interface controller 330, propulsion controller 331, path planning controller 334, tool position controllers 335, zone controller 336, downforce controllers 337, and control system 314 can include other items 339. Controllable subsystems 316 include downforce subsystem 341, depth subsystem 343, propulsion subsystem 350, steering subsystem 352, and subsystem 316 can include a wide variety of other controllable subsystems 356.

Interface controller 330 is operable to generate control signals to control interface mechanisms, such as operator interface mechanisms 318 or user interface mechanisms 364, or both. The interface controller 330 is also operable to present the predictive map 264 or predictive control zone map 265 or other information derived from or based on the predictive map 264, predictive control zone map 265, or both, to operator 360 or a remote user 366, or both. Operator 360 may be a local operator or a remote operator. As an example, interface controller 330 generates control signals to control a display mechanism to display one or both of predictive map 264 and predictive control zone map 265 for the operator 360 or a remote user 366, or both. Interface controller 330 may generate operator or user actuatable mechanisms that are displayed and can be actuated by the operator or user to interact with the displayed map. The operator or user can edit the map by, for example, correcting a value displayed on the map, based on the operator's or the user's observation.

Path planning controller 334 illustratively generates control signals to control steering subsystem 352 to steer mobile machine 100 according to a desired path or according to desired parameters, such as desired steering angles based on one or more of the predictive map 264 and the predictive control zone map 265. Path planning controller 334 can control a path planning system to generate a route for mobile machine 100 and can control propulsion subsystem 350 and steering subsystem 352 to steer mobile machine 100 along that route.

Propulsion controller 331 illustratively generates control signals to control propulsion subsystem 350 to control a speed characteristic of mobile machine 100, such as one or more of travel speed, acceleration, and deceleration, based on one or more of the predictive map 264 and the predictive control zone map 265. Propulsion subsystem 350 (e.g., 40) may include various power train components of mobile ground engaging machine 100, such as, but not limited to, an engine or motor, and a transmission (or gear box).

Tool position controllers 335 illustratively generate control signals to control tool positions (e.g., height or depth, angle, etc.) of one or more tools or tool assemblies of machine 100. For example, the tool position controllers 335 can generate control signals to control tool position subsystems 343 to control operation of the tool position subsystems 343 and thus an operating depth or operating angle, or both, of one or more ground engaging tools or tool assemblies of implement 101. The depth subsystems 343 may include various actuators that actuate to control a position of a tool implement 101. Some examples of these actuators are shown in previous FIGS., such as actuators 113, 153, 154, 183, 244, 246, 270, 272, 274, 276, and 278. Some of these actuators have not been previously shown, such as actuators that actuate wheels of implement 101, such as wheels 230. The various actuators can be hydraulic actuators, pneumatic actuators, electromechanical actuators, as well as various other types of actuators. In addition, tool position subsystems 343 can include delivery systems (e.g., fluid, such as hydraulic or air, delivery systems, power deliver systems, etc.), conduits, valves, pumps, and various other items. Tool position controllers 335 can thus generate control signals to control a position of one or more ground engaging tools of mobile machine 100. Tool position controllers 335 can generate control signals to control tool position subsystems 343 based on one or more of the predictive map 264 and the predictive control zone map 265.

Downforce controllers 337 illustratively generate control signals to control downforce exerted on one or more items (e.g., tools or tool assemblies) of mobile machine 100. For example, the downforce controllers 337 can generate control signals to control downforce subsystems 341 to control the operation of the downforce subsystems 343, and thus the downforces one or more items of implement 101. The downforce subsystems may include various actuators that apply a downforce to items of implement 101. Some examples of these actuators are shown in previous FIGS. The various actuators can be hydraulic actuators, pneumatic actuators, electromechanical actuators, as well as various other types of actuators. In particular examples, where the actuators are fluid actuators (such as hydraulic or pneumatic actuators) the downforce subsystem 341 can include accumulators that are associated with each actuator and are controllably pressurized to provide resistance against the actuators. In addition, downforce subsystems 341 can include delivery systems (e.g., fluid, such as hydraulic or air, delivery systems, power deliver systems, etc.), conduits, valves, pumps, and various other items. Downforce controllers 337 can thus generate control signals to control the downforce applied to individual tools or tool assemblies. Downforce controllers 337 can generate control signals to control downforce subsystems 341 based on one or more of the predictive map 264 and the predictive control zone map 265.

Zone controller 336 illustratively generates control signals to control one or more controllable subsystems 316 to control operation of the one or more controllable subsystems 316 based on the predictive control zone map 265.

Other controllers 339 included on the mobile machine 100, or at other locations in agricultural system 300, can control other subsystems 316 based on the predictive map 264 or predictive control zone map 265 or both as well.

While the illustrated example of FIG. 10 shows that various components of agricultural ground engaging system architecture 300 are located on mobile ground engaging machine 100, it will be understood that in other examples one or more of the components illustrated on mobile ground engaging machine 100 in FIG. 10 can be located at other locations, such as one or more remote computing systems 368. For instance, one or more of data stores 302, map selector 309, predictive model generator 310, predictive model 311, predictive map generator 312, functional predictive maps 263 (e.g., 264 and 265), control zone generator 313, and control system 314 can be located remotely from mobile machine 100 but can communicate with (or be communicated to) mobile machine 100 via communication system 306 and network 359. Thus, the predictive models 311 and functional predictive maps 263 may be generated at remote locations away from mobile machine 100 and communicated to mobile machine 100 over network 302, for instance, communication system 306 can download the predictive models 311 and functional predictive maps 263 from the remote locations and store them in data store 302. In other examples, mobile machine 100 may access the predictive models 311 and functional predictive maps 263 at the remote locations without downloading the predictive models 311 and functional predictive maps 263. The information used in the generation of the predictive models 311 and functional predictive maps 263 may be provided to the predictive model generator 310 and the predictive map generator 312 at those remote locations over network 359, for example in-situ sensor data generator by in-situ sensors 308 can be provided over network 359 to the remote locations. Similarly, information maps 358 can be provided to the remote locations.

In some examples, control system 314 may remain local to mobile machine 100, and a remote system (e.g., 368 or 364) may be provided with functionality (e.g., such as a control signal generator) that communicates control commands to mobile machine 100 that are used by control system 314 for the control of mobile ground engaging machine 100.

Similarly, where various components are located remotely from mobile machine 100, those components can receive data from components of mobile machine 100 over network 359. For example, where predictive model generator 310 and predictive map generator 312 are located remotely from mobile machine 100, such as at remote computing systems 368, data generated by in-situ sensors 308 and geographic position sensors 304, for instance, can be communicated to the remote computing systems 368 over network 359. Additionally, information maps 358 can be obtained by remote computing systems 368 over network 359 or over another network.

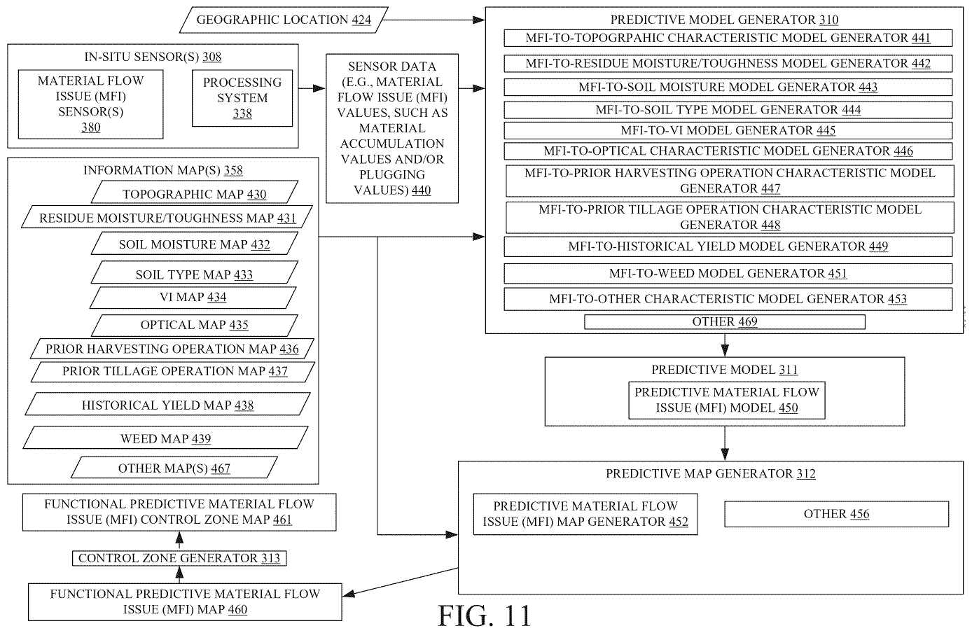

FIG. 11 is a block diagram of a portion of the agricultural ground engaging system architecture 300 shown in FIG. 10. Particularly, FIG. 11 shows, among other things, examples of the predictive model generator 310 and the predictive map generator 312 in more detail. FIG. 11 also illustrates information flow among the various components shown. The predictive model generator 310 receives one or more of a topographic map 430, a residue moisture/toughness map 431, a soil moisture map 432, a soil type map 433, a vegetive index (VI) map 434, an optical map 435, one or more prior operation maps, such as prior harvesting operation map 436 and prior tillage operation map 437, a historical yield map 438. a weed map 439, and another type of map 467. Predictive model generator 310 also receives a geographic location 424, or an indication of a geographic location, such as from geographic positions sensor 304. Geographic location 424 illustratively represents the geographic location of a value detected by in-situ sensors 308. In some examples, the geographic position of the mobile machine 100, as detected by geographic position sensors 304, will not be the same as the geographic position on the field to which a value detected by in-situ sensors 308 corresponds. It will be appreciated, that the geographic position indicated by geographic position sensor 304, along with timing, machine speed and heading, machine dimensions, sensor position (e.g., relative to geographic position sensor), sensor parameters (e.g., sensor field of view), as well as various other data, can be used to derive a geographic location at the field to which a value a detected by an in-situ sensor 308 corresponds.

In-situ sensors 308 illustratively material flow issue sensors 380, as well as processing system 338. In some examples, processing system 338 is separate from in-situ sensors 308 (such as the example shown in FIG. 10). In some instances, material flow issue sensors 380 may be located on-board mobile ground engaging machine 100. The processing system 338 processes sensor data generated from material flow issue sensors 380 to generate processed sensor data 440 indicative of material flow issue (MFI) values. The MFI values may indicate material flow issues, such as material accumulation or plugging, or both.

As shown in FIG. 11, the example predictive model generator 310 includes a material flow issue (MFI)-to-topographic characteristic model generator 441, a material flow issue (MFI)-to-residue moisture/toughness model generator 442, a material flow issue (MFI)-to-soil moisture model generator 443, a material flow issue (MFI)-to-soil type model generator 444, a material flow issue (MFI)-to-vegetative index (VI) model generator 445, a material flow issue (MFI)-to-optical characteristic model generator 446, a material flow issue (MFI)-to-prior harvesting operation characteristic model generator 447, a material flow issue (MFI)-to-prior tillage operation characteristic model generator 448, a material flow issue (MFI)-to-historical yield model generator 449, a material flow issue (MFI)-to-weed model generator 451, and a material flow issue (MFI)-to-other characteristic model generator 453. In other examples, the predictive model generator 310 may include additional, fewer, or different components than those shown in the example of FIG. 11. Consequently, in some examples, the predictive model generator 310 may include other items 469 as well, which may include other types of predictive model generators to generate other types of material flow issue models.

MFI-to-topographic characteristic model generator 441 identifies a relationship between MFI value(s) detected in in-situ sensor data 440, at geographic location(s) to which the MFI value(s), detected in the in-situ sensor data 440, correspond, and topographic characteristic value(s) from the topographic map 430 corresponding to the same geographic location(s) to which the detected MFI value(s) correspond. Based on this relationship established by MFI-to-topographic characteristic model generator 441, MFI-to-topographic characteristic model generator 441 generates a predictive material flow issue (MFI) model. The predictive MFI model is used by predictive material flow issue (MFI) map generator 452 to predict material flow issue(s) (e.g., one or more of material accumulation and plugging) at different locations in the field based upon the georeferenced topographic characteristic values contained in the topographic map 430 at the same locations in the field. Thus, for a given location in the field, a MFI value can be predicted at the given location based on the predictive MFI model and the topographic characteristic value, from the topographic map 430, at that given location.

MFI-to-residue moisture/toughness model generator 442 identifies a relationship between MFI value(s) detected in in-situ sensor data 440, at geographic location(s) to which the MFI value(s), detected in the in-situ sensor data 440, correspond, and residue moisture/toughness value(s) from the residue moisture/toughness map 431 corresponding to the same geographic location(s) to which the detected MFI value(s) correspond. Based on this relationship established by MFI-to-residue moisture/toughness model generator 442, MFI-to-residue moisture/toughness model generator 442 generates a predictive MFI model. The predictive MFI model is used by predictive MFI map generator 452 to predict material flow issue(s) (e.g., one or more of material accumulation and plugging) at different locations in the field based upon the georeferenced residue moisture/toughness values contained in the residue moisture/toughness map 431 at the same locations in the field. Thus, for a given location in the field, a MFI value can be predicted at the given location based on the predictive MFI model and the residue moisture/toughness value, from the residue moisture/toughness map 431, at that given location.

MFI-to-soil moisture model generator 443 identifies a relationship between MFI value(s) detected in in-situ sensor data 440, at geographic location(s) to which the MFI value(s), detected in the in-situ sensor data 440, correspond, and soil moisture value(s) from the soil moisture map 432 corresponding to the same geographic location(s) to which the detected MFI value(s) correspond. Based on this relationship established by MFI-to-soil moisture model generator 443, MFI-to-soil moisture model generator 443 generates a predictive MFI model. The predictive MFI model is used by predictive material flow issue (MFI) map generator 452 to predict material flow issue(s) (e.g., one or more of material accumulation and plugging) at different locations in the field based upon the georeferenced soil moisture values contained in the soil moisture map 432 at the same locations in the field. Thus, for a given location in the field, a MFI value can be predicted at the given location based on the predictive MFI model and the soil moisture value, from the soil moisture map 432, at that given location.

MFI-to-soil type model generator 444 identifies a relationship between MFI value(s) detected in in-situ sensor data 440, at geographic location(s) to which the MFI value(s), detected in the in-situ sensor data 440, correspond, and soil type value(s) from the soil type map 433 corresponding to the same geographic location(s) to which the detected MFI value(s) correspond. Based on this relationship established by MFI-to-soil type model generator 444, MFI-to-soil type model generator 444 generates a predictive MFI model. The predictive MFI model is used by predictive MFI map generator 452 to predict material flow issue(s) (e.g., one or more of material accumulation and plugging) at different locations in the field based upon the georeferenced soil type values contained in the soil type map 433 at the same locations in the field. Thus, for a given location in the field, a MFI value can be predicted at the given location based on the predictive MFI model and the soil type value, from the soil type map 433, at that given location.

MFI-to-VI model generator 445 identifies a relationship between MFI value(s) detected in in-situ sensor data 440, at geographic location(s) to which the MFI value(s), detected in the in-situ sensor data 440, correspond, and vegetative index (VI) value(s) from the VI map 434 corresponding to the same geographic location(s) to which the detected MFI value(s) correspond. Based on this relationship established by MFI-to-VI model generator 445, MFI-to-VI model generator 445 generates a predictive MFI model. The predictive MFI model is used by predictive MFI map generator 452 to predict material flow issue(s) (e.g., one or more of material accumulation and plugging) at different locations in the field based upon the georeferenced VI values contained in the VI map 434 at the same locations in the field. Thus, for a given location in the field, a MFI value can be predicted at the given location based on the predictive MFI model and the VI value, from the VI map 434, at that given location.

MFI-to-optical characteristic model generator 446 identifies a relationship between MFI value(s) detected in in-situ sensor data 440, at geographic location(s) to which the MFI value(s), detected in the in-situ sensor data 440, correspond, and optical characteristic value(s) from the optical map 435 corresponding to the same geographic location(s) to which the detected MFI value(s) correspond. Based on this relationship established by MFI-to-optical characteristic model generator 446, MFI-to-optical characteristic model generator 446 generates a predictive MFI model. The predictive MFI model is used by predictive MFI map generator 452 to predict material flow issue(s) (e.g., one or more of material accumulation and plugging) at different locations in the field based upon the georeferenced optical characteristic values contained in the optical map 435 at the same locations in the field. Thus, for a given location in the field, a MFI value can be predicted at the given location based on the predictive MFI model and the optical characteristic value, from the optical map 435, at that given location.

MFI-to-prior harvesting operation characteristic model generator 447 identifies a relationship between MFI value(s) detected in in-situ sensor data 440, at geographic location(s) to which the MFI value(s), detected in the in-situ sensor data 440, correspond, and prior harvesting operation characteristic value(s) from a prior harvesting operation map 436 corresponding to the same geographic location(s) to which the detected MFI value(s) correspond. Based on this relationship established by MFI-to-prior harvesting operation characteristic model generator 447, MFI-to-prior harvesting operation characteristic model generator 447 generates a predictive MFI model. The predictive MFI model is used by predictive MFI map generator 452 to predict material flow issue(s) (e.g., one or more of material accumulation and plugging) at different locations in the field based upon the georeferenced prior harvesting operation characteristic values contained in the prior harvesting operation map 436 at the same locations in the field. Thus, for a given location in the field, a MFI value can be predicted at the given location based on the predictive MFI model and the prior harvesting operation characteristic value, from the prior harvesting operation map 436, at that given location.

MFI-to-prior tillage operation characteristic model generator 448 identifies a relationship between MFI value(s) detected in in-situ sensor data 440, at geographic location(s) to which the MFI value(s), detected in the in-situ sensor data 440, correspond, and prior tillage operation characteristic value(s) from a prior tillage operation map 437 corresponding to the same geographic location(s) to which the detected MFI value(s) correspond. Based on this relationship established by MFI-to-prior tillage operation characteristic model generator 448, MFI-to-prior tillage operation characteristic model generator 448 generates a predictive MFI model. The predictive MFI model is used by predictive MFI map generator 452 to predict material flow issue(s) (e.g., one or more of material accumulation and plugging) at different locations in the field based upon the georeferenced prior tillage operation characteristic values contained in the prior tillage operation map 437 at the same locations in the field. Thus, for a given location in the field, a MFI value can be predicted at the given location based on the predictive MFI model and the prior tillage operation characteristic value, from the prior tillage operation map 437, at that given location.

MFI-to-historical yield model generator 449 identifies a relationship between MFI value(s) detected in in-situ sensor data 440, at geographic location(s) to which the MFI value(s), detected in the in-situ sensor data 440, correspond, and historical yield value(s) from the historical yield map 438 corresponding to the same geographic location(s) to which the detected MFI value(s) correspond. Based on this relationship established by MFI-to-historical yield model generator 449, MFI-to-historical yield model generator 449 generates a predictive MFI model. The predictive MFI model is used by predictive MFI map generator 452 to predict material flow issue(s) (e.g., one or more of material accumulation and plugging) at different locations in the field based upon the georeferenced optical characteristic values contained in the historical yield map 438 at the same locations in the field. Thus, for a given location in the field, a MFI value can be predicted at the given location based on the predictive MFI model and the historical yield value, from the historical yield map 438, at that given location.

MFI-to-weed model generator 451 identifies a relationship between MFI value(s) detected in in-situ sensor data 440, at geographic location(s) to which the MFI value(s), detected in the in-situ sensor data 440, correspond, and weed value(s) from the weed map 439 corresponding to the same geographic location(s) to which the detected MFI value(s) correspond. Based on this relationship established by MFI-to-weed model generator 451, MFI-to-weed model generator 451 generates a predictive MFI model. The predictive MFI model is used by predictive MFI map generator 452 to predict material flow issue(s) (e.g., one or more of material accumulation and plugging) at different locations in the field based upon the georeferenced weed values contained in the weed map 439 at the same locations in the field. Thus, for a given location in the field, a MFI value can be predicted at the given location based on the predictive MFI model and the weed value, from the weed map 439, at that given location.

MFI-to-other characteristic model generator 453 identifies a relationship between MFI value(s) detected in in-situ sensor data 440, at geographic location(s) to which the MFI value(s), detected in the in-situ sensor data 440, correspond, and other characteristic value(s) from an other map 467 corresponding to the same geographic location(s) to which the detected MFI value(s) correspond. Based on this relationship established by MFI-to-other characteristic model generator 453, MFI-to-other characteristic model generator 453 generates a predictive MFI model. The predictive MFI model is used by predictive MFI map generator 452 to predict material flow issue(s) (e.g., one or more of material accumulation and plugging) at different locations in the field based upon the georeferenced other characteristic values contained in the other map 467 at the same locations in the field. Thus, for a given location in the field, a MFI value can be predicted at the given location based on the predictive MFI model and the other characteristic value, from the other map 467, at that given location.

In light of the above, the predictive model generator 310 is operable to produce a plurality of predictive MFI models, such as one or more of the predictive MFI models generated by model generators 441, 442, 443, 444, 445, 446, 447, 448, 449, 451, 453, and 469. In another example, two or more of the predictive models described above may be combined into a single predictive MFI model, such as a predictive MFI model that predicts material flow issue(s) based upon two or more of the topographic values, the residue moisture/toughness values, the soil moisture values, the soil type values, the vegetative index (VI) values, the optical characteristic values, the prior harvesting operation characteristic values, the prior tillage operation characteristic values, the historical yield values, the weed values, and the other characteristic values at different locations in the field. Any of these MFI models, or combinations thereof, are represented collectively by predictive material flow issue (MFI) model 450 in FIG. 11.

The predictive MFI model 450 is provided to predictive map generator 312. In the example of FIG. 11, predictive map generator 312 includes a predictive material flow issue (MFI) map generator 452. In other examples, predictive map generator 312 may include additional or different map generators. Thus, in some examples, predictive map generator 312 may include other items 456 which may include other types of map generators to generate other types of maps.

Predictive MFI map generator 452 receives one or more of the topographic map 430, the residue moisture/toughness map 431, the soil moisture map 432, the soil type map 433, the VI map 434, the optical map 435, the prior harvesting operation map 436, the prior tillage operation map 437, the historical yield map 438, the weed map 439, and an other map 467, along with the predictive MFI model 450 which predicts material flow issue(s) based upon one or more of a topographic value, a residue moisture/toughness value, a soil moisture value, a soil type value, a VI value, an optical characteristic value, a prior harvesting operation characteristic value, a prior tillage operation characteristic value, a historical yield value, a weed value, and an other characteristic value, and generates a predictive map that predicts material flow issue(s) at different locations in the field, such as functional predictive material flow issue (MFI) map 460.

Predictive map generator 312 outputs a functional predictive MFI map 460 that is predictive of material flow issue(s) (e.g., one or more of material accumulation and plugging). The functional predictive MFI map 460 is a predictive map 264. The functional predictive MFI map 460 predicts material flow issue(s0 at different locations in a field. The functional predictive MFI map 460 may be provided to control zone generator 313, control system 314, or both. Control zone generator 313 generates control zones and incorporates those control zones into the functional predictive MFI map 460 to produce a predictive control zone map 265, that is a functional predictive material flow issue (MFI) control zone map 461. One or both of functional predictive MFI map 460 and functional predictive MFI control zone map 461 may be provided to control system 314, which generates control signals to control one or more of the controllable subsystems 316 based upon the functional predictive MFI map 460, the functional predictive MFI control zone map 461, or both.

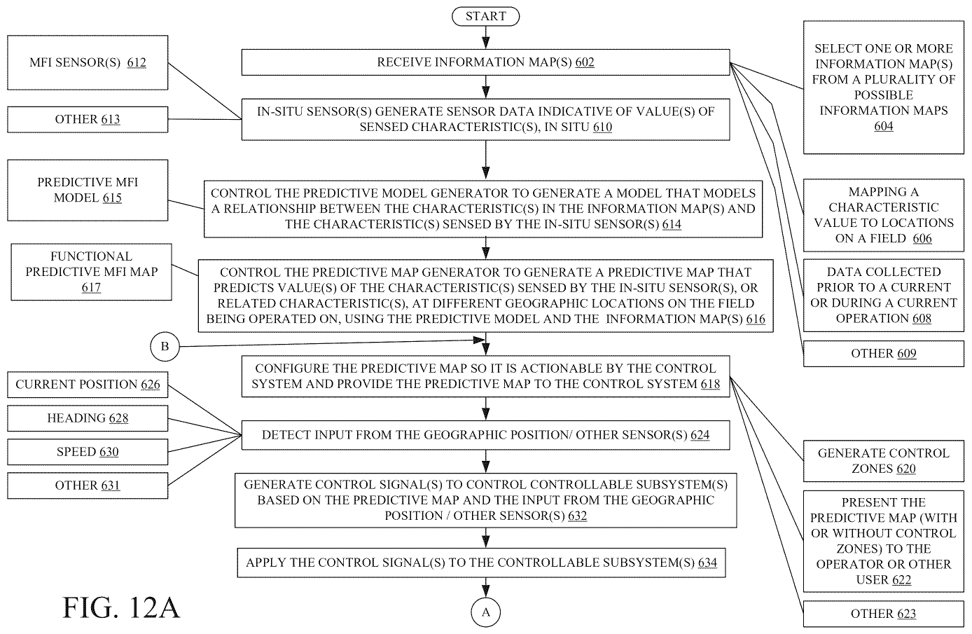

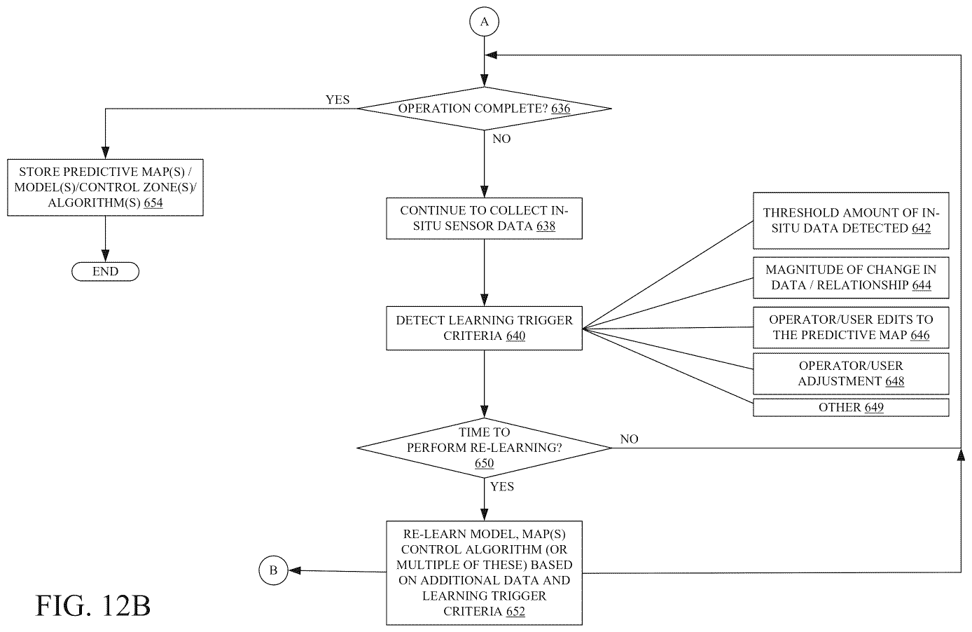

FIGS. 12A-12B (collectively referred to herein as FIG. 12) show a flow diagram illustrating one example of the operation of agricultural ground engaging system architecture 300 in generating a predictive model and a predictive map.

At block 602, agricultural system 300 receives one or more information maps 358. Examples of information maps 358 or receiving information maps 358 are discussed with respect to blocks 604, 606, 608, and 609. As discussed above, information maps 358 map values of a variable, corresponding to a characteristic, to different locations in the field, as indicated at block 606. As indicated at block 604, receiving the information maps 358 may involve selecting one or more of a plurality of possible information maps 358 that are available. For instance, one information map 358 may be a topographic map, such as topographic map 430. Another information map 358 may be a residue moisture/toughness map, such as residue moisture/toughness map 431. Another information map 358 may be a soil moisture map, such as soil moisture map 432. Another information map 358 may be a soil type map, such as soil type map 433. Another information map 358 may be a vegetative index (VI) map, such as VI map 434. Another information map 358 may be an optical map, such as optical map 435. Another information map 358 may be a prior operation map, for instance a prior harvesting operation map, such as prior harvesting operation map 436. Another information map 358 may be a prior operation map, for instance a prior tillage operation map, such as prior tillage operation map 437. Another information map 358 may be a historical yield map, such as historical yield map 438. Another information map 358 may be a weed map, such as weed map 439. Information maps 358 may include various other types of maps that map various other characteristics, such as other maps 467.

The process by which one or more information maps 358 are selected can be manual, semi-automated, or automated. The information maps 358 can be based on data collected prior to a current operation or based on data collected during a current operation as indicated by block 608. For instance, the data may be collected based on aerial images taken during a previous year, or earlier in the current season, or at other times. The data may be based on data detected in ways other than using aerial images. For instance, the data may be collected during a previous operation on the worksite, such an operation during a previous year, or a previous operation earlier in the current season, or at other times. The machines performing those previous operations may be outfitted with one or more sensors that generate sensor data indicative of one or more characteristics. For example, the sensed characteristics (e.g., characteristics of the field, characteristics of the vegetation, characteristics of the environment, operating parameters, etc.) during a previous operation be used as data to generate the information maps 358. In other examples, and as described above, the information maps 358 may be predictive maps having predictive values, such as a predictive soil moisture map having predictive soil moisture values, or another type of predictive map having predictive values of another characteristic. The predictive information map 358 can be generated by predictive map generator 312 based on a model generated by predictive model generator 310. The data for the information maps 358 can be obtained by agricultural system 300 using communication system 306 and stored in data store 302. The data for the information maps 358 can be obtained by agricultural system 300 using communication system 306 in other ways as well, and this is indicated by block 609 in the flow diagram of FIG. 12.

As mobile ground engaging machine 100 is operating, in-situ sensors 308 generate sensor data (e.g., signals, images, etc.) indicative of one or more in-situ data values indicative of a characteristic, as indicated by block 610. For example, material flow issue sensors 380 generate sensor data indicative of one or more in-situ data values indicative of one or more material flow issue(s) (e.g., one or more of material accumulation and plugging), as indicated by block 611. In some examples, data from in-situ sensors 308 is georeferenced using position, heading, or speed data, as well as machine dimension information, sensor position information, sensor parameter information, etc.

At block 614, predictive model generator 310 controls one or more of the model generators 441, 442, 443, 444, 445, 446, 447, 448, 449, 451, 453, and 469 to generate a model that models the relationship between the mapped values, such as the topographic values, the residue moisture/toughness values, the soil moisture values, the soil type values, the vegetative index (VI) values, the optical characteristic values, the prior harvesting operation characteristic values, the prior tillage operation characteristic values, the historical yield values, the weed values, and the other characteristic values contained in the respective information map and the MFI values sensed by the in-situ sensors 308. Predictive model generator 310 generates a predictive MFI model 450 that predicts MFI values based on one or more of topographic values, residue moisture/toughness values, soil moisture values, soil type values, VI values, optical characteristic values, prior harvesting operation characteristic values, prior tillage operation characteristic values, historical yield values, weed values, and other characteristic values, as indicated by block 615.

At block 616, the relationship(s) or model(s) generated by predictive model generator 310 is provided to predictive map generator 312. Predictive map generator 312 generates a functional predictive MFI map 460 that predicts MFI values (or sensor values indicative of material flow issue(s)) at different geographic locations in a field at which mobile ground engaging machine 100 is operating using the predictive MFI model 450 and one or more of the information maps 358, such as topographic map 430, residue moisture/toughness map 431, soil moisture map 432, soil type map 433, VI map 434, optical map 435, prior harvesting operation map 436, prior tillage operation map 437, historical yield map 438, weed map 439, and an other map 467.

It should be noted that, in some examples, the functional predictive MFI map 460 may include two or more different map layers. Each map layer may represent a different data type, for instance, a functional predictive MFI map 460 that provides two or more of a map layer that provides predictive material flow issue(s) based on topographic characteristic values from topographic map 430, a map layer that provides predictive material flow issue(s) based on residue moisture/toughness values from residue moisture/toughness map 431, a map layer that provides predictive material flow issue(s) based on soil moisture values from soil moisture map 432, a map layer that provides predictive material flow issue(s) based on soil type values from soil type map 433, a map layer that provides predictive material flow issue(s) based on VI values from VI map 434, a map layer that provides predictive material flow issue(s) based on optical characteristic values from optical map 435, a map layer that provides predictive material flow issue(s) based on prior harvesting operation characteristic values from prior harvesting operation map 436, a map layer that provides predictive material flow issue(s) based on prior tillage operation characteristic values from prior tillage operation map 437, a map layer that provides predictive material flow issue(s) based on historical yield values from historical yield map 438, a map layer that provides predictive material flow issue(s) based on weed values from weed map 439, and a map layer that provides predictive material flow issue(s) based on other characteristic values from an other map 467. Additionally, or alternatively, functional predictive MFI map 460 can include a map layer that provides predictive material flow issue(s) based on two or more of topographic characteristic values from topographic map 430, residue moisture/toughness values from residue moisture/toughness map 431, soil moisture values from soil moisture map 432, soil type values from soil type map 433, VI values from VI map 434, optical characteristic values from optical map 435, prior harvesting operation characteristic values from prior harvesting map 436, prior tillage operation characteristic values from prior tillage operation map 437, historical yield values from historical yield map 438, weed values from weed map 439, and other characteristic values from an other map 467.

Providing a predictive material flow issue map, such as functional predictive material flow issue (MFI) map 460 is indicated by block 617.

At block 618, predictive map generator 312 configures the functional predictive MFI map 460 so that the functional predictive MFI map 460 is actionable (or consumable) by control system 314. Predictive map generator 312 can provide the functional predictive MFI map 460 to the control system 314 or to control zone generator 313, or both. Some examples of the different ways in which the functional predictive MFI map 460 can be configured or output are described with respect to blocks 618, 620, 622, and 623. For instance, predictive map generator 312 configures functional predictive MFI map 460 so that functional predictive MFI map 460 includes values that can be read by control system 314 and used as the basis for generating control signals for one or more of the different controllable subsystems 316 of mobile ground engaging machine 100, as indicated by block 618.

At block 620, control zone generator 313 can divide the functional predictive MFI map 460 into control zones based on the values on the functional predictive MFI map 460 to generate functional predictive material flow issue (MFI) control zone map 461. Contiguously-geolocated values that are within a threshold value of one another can be grouped into a control zone. The threshold value can be a default threshold value, or the threshold value can be set based on an operator input, based on an input from an automated system, or based on other criteria. A size of the zones may be based on a responsiveness of the control system 314, the controllable subsystems 316, based on wear considerations, or on other criteria.

At block 622, predictive map generator 312 configures functional predictive MFI map 460 for presentation to an operator or other user. At block 622, control zone generator 313 can configure functional predictive MFI control zone map 461 for presentation to an operator or other user. When presented to an operator or other user, the presentation of the functional predictive MFI map 460 or of functional predictive MFI control zone map 461, or both, may contain one or more of the predictive values on the functional predictive MFI map 460 correlated to geographic location, the control zones of functional predictive MFI control zone map 461 correlated to geographic location, and settings values or control parameters that are used based on the predicted values on functional predictive MFI map 460 or control zones on functional predictive MFI control zone map 461. The presentation can, in another example, include more abstracted information or more detailed information. The presentation can also include a confidence level that indicates an accuracy with which the predictive values on functional predictive MFI map 460 or the control zones on functional predictive MFI control zone map 461 conform to measured values that may be measured by sensors on mobile ground engaging machine 100 as mobile ground engaging machine 100 operates at the worksite. Further where information is presented to more than one location, an authentication and authorization system can be provided to implement authentication and authorization processes. For instance, there may be a hierarchy of individuals that are authorized to view and change maps and other presented information. By way of example, an on-board display device may show the maps in near real time locally on the machine, or the maps may also be generated at one or more remote locations, or both. In some examples, each physical display device at each location may be associated with a person or a user permission level. The user permission level may be used to determine which display elements are visible on the physical display device and which values the corresponding person may change. As an example, a local operator of mobile ground engaging machine 100 may be unable to see the information corresponding to the functional predictive MFI map 460 or make any changes to machine operation. A supervisor, such as a supervisor at a remote location, however, may be able to see the functional predictive MFI map 460 on the display but be prevented from making any changes. A manager, who may be at a separate remote location, may be able to see all of the elements on functional predictive MFI map 460 and also be able to change the functional predictive MFI map 460. In some instances, the functional predictive MFI map 460 accessible and changeable by a manager located remotely may be used in machine control. This is one example of an authorization hierarchy that may be implemented. The functional predictive MFI map 460 or functional predictive MFI control zone map 461, or both, can be configured in other ways as well, as indicated by block 623.

At block 624, input from geographic position sensor 304 and other in-situ sensors 308 are received by the control system 314. Particularly, at block 626, control system 314 detects an input from the geographic position sensor 304 identifying a geographic location of mobile ground engaging machine 100. Block 628 represents receipt by the control system 314 of sensor inputs indicative of trajectory or heading of mobile ground engaging machine 100, and block 630 represents receipt by the control system 314 of a speed of mobile ground engaging machine 100. Block 631 represents receipt by the control system 314 of other information from various other in-situ sensors 308.

At block 632, control system 314 generates control signals to control the controllable subsystems 316 based on the functional predictive MFI map 460 or the functional predictive MFI control zone map 461, or both, and the input from the geographic position sensor 304 and any other in-situ sensors 308. At block 634, control system 314 applies the control signals to the controllable subsystems 316. It will be appreciated that the particular control signals that are generated, and the particular controllable subsystems 316 that are controlled, may vary based upon one or more different things. For example, the control signals that are generated and the controllable subsystems 316 that are controlled may be based on the type of functional predictive MFI map 460 or functional predictive MFI control zone map 461, or both, that is being used. Similarly, the control signals that are generated and the controllable subsystems 316 that are controlled and the timing of the control signals can be based on various latencies of mobile machine 100 and the responsiveness of the controllable subsystems 316.

By way of example, propulsion controller 331 of control system 314 can generate control signals to control propulsion subsystem 350 to control one or more propulsion parameters (e.g., speed characteristics) of mobile machine 100, such as one or more of the speed at which the mobile machine travels, the deceleration of mobile machine 100, and the acceleration of mobile machine 100, based on the functional predictive MFI map 460 or the functional predictive MFI control zone map 461, or both.

In another example, path planning controller 334 of control system 314 can generate control signals to control steering subsystem 352 to control a route parameter of mobile machine 100, such as one or more of a commanded path at the worksite over which mobile machine 100 travels, and the steering of mobile machine 100, based on the functional predictive MFI map 460 or the functional predictive MFI control zone map 461, or both. As an example, path planning controller 334 may generate a route and/or control the steering of mobile machine 100 such that mobile machine 100 travels over a location more than once. In another example, path planning controller 334 may generate a route and/or control the steering of mobile machine 100 such that mobile machine 100 avoids travel over a location at the worksite. For instance, the map 460 or map 461, or both, may predict material flow issue(s) (e.g., one or more of material accumulation and plugging) in areas of the field, in which case, path planning controller 334 may generate a route and/or control the mobile machine 100 to avoid such areas. In another example, path planning controller 334 may generate a route and/or control the steering of mobile machine 100 such that mobile machine 100 travels to another location (e.g., a different field, back to storage facility, etc.). For instance, the map 460 or map 461, or both, may predict material flow issue(s) at multiple locations across a field, such that further operation on the field should wait until a later time, in which case, path planning controller 334 may generate a route and/or control the mobile machine 100 to travel to another location.

In another example, one or more tool position controllers 335 of control system 314 can generate control signals to control one or more tool position subsystems 343. For example, tool position controllers 335 can generate control signals to control the heights or depths and/or angles of one or more tools of implement 101. Tool position controllers 335 can generates control signals based on the functional predictive MFI map 460 or the functional predictive MFI control zone map 461, or both. For example, tool position controllers 335 may generate control signals to raise one or more of the tools (e.g., reduce depth or be taken out of engagement with the ground altogether) or to engage tools with the ground, such as where the MFI map 460 predicts no or low levels of MFI issues. For instance, map 460 or map 461, or both, may predict material flow issue(s) in areas of the field, in which case, tool position controllers 335 may generate control signals to raise one or more tools (to reduce depth or to take the one or more tools out of engagement with the ground) at those locations. For instance, it may be that the tools are raised to mitigate material accumulation or to avoid plugging. Those areas can be marked and operated on at another time, such as after the soil has had additional time to dry. In another example, tool position controllers 335 can generate control signals to change an angle of the tools. For instance, map 460 or map 461, or both, may predict material flow issue(s) in areas of the field, in which case, tool position controllers 335 may generate control signals to decrease an angle of a tool (e.g., decrease aggressiveness) in those areas to mitigate material accumulation or plugging. In other examples, the tool position controllers 335 may lower one or more tools (e.g., increase depth or bring the tools into engagement with the ground) or increase an angle (e.g., increase an aggressiveness), or both. For instance, the map 460 or map 461, or both, may predict that material flow issue(s) are not likely for areas of the field, in which case the tools can be lowered or the angles can be increased in those areas.

In another example, one or more downforce controllers 337 of control system 314 can generate control signals to control one or more downforce subsystems 341. For example, downforce controllers 337 can generate control signals to control the downforce applied to one or items (e.g., tools or tool assemblies) of mobile machine 100 on the functional predictive MFI map 460 or the functional predictive MFI control zone map 461, or both. For instance, the map 460 or map 461, or both, may predict material flow issue(s) in areas of the field, in which case, the downforce applied to one or more items can be reduced in those areas to mitigate material accumulation or plugging. In another example, the map 460 or map 461, or both, may predict that material flow issue(s) are not likely in areas of the field, in which case, the downforce applied to one or more items can be increased in those areas.

In another example, interface controller 330 of control system 314 can generate control signals to control an interface mechanism (e.g., 218 or 364) to generate a display, alert, notification, or other indication based on or indicative of functional predictive MFI map 460 or functional predictive MFI control zone map 461, or both. For example, an alert or other indication, that notifies operator 360 or user 366, or both, that the mobile machine 100 is approaching an area with predictive material flow issue(s).

In another example, communication system controller 329 of control system 314 can generate control signals to control communication system 306 to communicate functional predictive MFI map 460 or functional predictive MFI control zone map 461, or both, to another item of agricultural system 300 (e.g., remote computing systems 368 or user interfaces 364).

These are merely examples. Control system 314 can generate various other control signals to control various other items of mobile machine 100 (or agricultural system 300) based on functional predictive MFI map 460 or functional predictive MFI control zone map 461, or both.

At block 636, a determination is made as to whether the operation has been completed. If the operation is not completed, the processing advances to block 638 where in-situ sensor data from geographic position sensor 304 and in-situ sensors 308 (and perhaps other sensors) continue to be read.

In some examples, at block 640, agricultural ground engaging system 300 can also detect learning trigger criteria to perform machine learning on one or more of the functional predictive MFI map 460, functional predictive MFI control zone map 461, predictive MFI model 450, the zones generated by control zone generator 313, one or more control algorithms implemented by the controllers in the control system 314, and other triggered learning.

The learning trigger criteria can include any of a wide variety of different criteria. Some examples of detecting trigger criteria are discussed with respect to blocks 642, 644, 646, 648, and 649. For instance, in some examples, triggered learning can involve recreation of a relationship used to generate a predictive model when a threshold amount of in-situ sensor data are obtained from in-situ sensors 308. In such examples, receipt of an amount of in-situ sensor data from the in-situ sensors 308 that exceeds a threshold triggers or causes the predictive model generator 310 to generate a new predictive model that is used by predictive map generator 312. Thus, as mobile machine 100 continues an operation, receipt of the threshold amount of in-situ sensor data from the in-situ sensors 308 triggers the creation of a new relationship represented by a new MFI depth model 450 generated by predictive model generator 310. Further, a new functional predictive MFI map 460, a new functional predictive MFI control zone map 461, or both, can be generated using the new predictive MFI model 450. Block 642 represents detecting a threshold amount of in-situ sensor data used to trigger creation of a new predictive model.

In other examples, the learning trigger criteria may be based on how much the in-situ sensor data from the in-situ sensors 308 are changing, such as over time or compared to previous values. For example, if variations within the in-situ sensor data (or the relationship between the in-situ sensor data and the information in the one or more information maps 358) are within a selected range or is less than a defined amount, or below a threshold value, then a new predictive model is not generated by the predictive model generator 310. As a result, the predictive map generator 312 does not generate a new functional predictive MFI map 460, a new functional predictive MFI control zone map 461, or both. However, if variations within the in-situ sensor data are outside of the selected range, are greater than the defined amount, or are above the threshold value, for example, then the predictive model generator 310 generates a new predictive MFI model 450 using all or a portion of the newly received in-situ sensor data that the predictive map generator 312 uses to generate a new functional predictive MFI map 460 which can be provided to control zone generator 313 for the creation of a new functional predictive MFI control zone map 461. At block 644, variations in the in-situ sensor data, such as a magnitude of an amount by which the data exceeds the selected range or a magnitude of the variation of the relationship between the in-situ sensor data and the information in the one or more information maps, can be used as a trigger to cause generation of one or more of a new predictive MFI model 450, a new functional predictive MFI map 460, and a new functional predictive MFI control zone map 461. Keeping with the examples described above, the threshold, the range, and the defined amount can be set to default values; set by an operator or user interaction through a user interface; set by an automated system; or set in other ways.

Other learning trigger criteria can also be used. For instance, if predictive model generator 310 switches to a different information map (different from the originally selected information map), then switching to the different information map may trigger re-learning by predictive model generator 310, predictive map generator 312, control zone generator 313, control system 314, or other items. In another example, transitioning of mobile machine 100 to a different topography or to a different control zone may be used as learning trigger criteria as well.

In some instances, operator 360 or user 366 can also edit the functional predictive MFI map 460 or functional predictive MFI control zone map 461, or both. The edits can change a value on the functional predictive MFI map 460, change a size, shape, position, or existence of a control zone on functional predictive MFI control zone map 461, or both. Block 646 shows that edited information can be used as learning trigger criteria.

In some instances, it may also be that operator 360 or user 366 observes that automated control of a controllable subsystem 316, is not what the operator or user desires. In such instances, the operator 360 or user 366 may provide a manual adjustment to the controllable subsystem 316 reflecting that the operator 360 or user 366 desires the controllable subsystem 316 to operate in a different way than is being commanded by control system 314. Thus, manual alteration of a setting by the operator 360 or user 366 can cause one or more of predictive model generator 310 to generate a new predictive MFI model 450, predictive map generator 312 to generate a new functional predictive MFI map 460, control zone generator 313 to generate one or more new control zones on functional predictive MFI control zone map 461, and control system 314 to relearn a control algorithm or to perform machine learning on one or more of the controller components 329 through 339 in control system 314 based upon the adjustment by the operator 360 or user 366, as shown in block 648. Block 649 represents the use of other triggered learning criteria.

In other examples, relearning may be performed periodically or intermittently based, for example, upon a selected time interval such as a discrete time interval or a variable time interval, as indicated by block 650.

If relearning is triggered, whether based upon learning trigger criteria or based upon passage of a time interval, as indicated by block 650, then one or more of the predictive model generator 310, predictive map generator 312, control zone generator 313, and control system 314 performs machine learning to generate a new predictive model, a new predictive map, a new control zone, and a new control algorithm, respectively, based upon the learning trigger criteria. The new predictive model, the new predictive map, the new control zone, and the new control algorithm are generated using any additional data that has been collected since the last learning operation was performed. Performing relearning is indicated by block 652.

If the operation has been completed, operation moves from block 652 to block 654 where one or more of the functional predictive MFI map 460, functional predictive MFI control zone map 461, the predictive MFI model 450, the control zone(s), and the control algorithm(s), are stored. The functional predictive MFI map 460, functional predictive MFI control zone map 461, predictive MFI model 450, control zone(s), and control algorithm(s), may be stored locally on data store 302 or sent to a remote system using communication system 306 for later use.

If the operation has not been completed, operation moves from block 652 to block 618 such that the one or more of the new predictive model, the new functional predictive map, the new functional predictive control zone map, the new control zone(s), and the new control algorithm(s) can be used in the control of mobile ground engaging machine 100.

The examples herein describe the generation of a predictive model and, in some examples, the generation of a functional predictive map based on the predictive model. The examples described herein are distinguished from other approaches by the use of a model which is at least one of multi-variate or site-specific (i.e., georeferenced, such as map-based). Furthermore, the model is revised as the work machine is performing an operation and while additional in-situ sensor data is collected. The model may also be applied in the future beyond the current worksite. For example, the model may form a baseline (e.g., starting point) for a subsequent operation at a different worksite or the same worksite at a future time.

The revision of the model in response to new data may employ machine learning methods. Without limitation, machine learning methods may include memory networks, Bayes systems, decisions trees, Eigenvectors, Eigenvalues and Machine Learning, Evolutionary and Genetic Algorithms, Cluster Analysis, Expert Systems/Rules, Support Vector Machines, Engines/Symbolic Reasoning, Generative Adversarial Networks (GANs), Graph Analytics and ML, Linear Regression, Logistic Regression, LSTMs and Recurrent Neural Networks (RNNSs), Convolutional Neural Networks (CNNs), MCMC, Random Forests, Reinforcement Learning or Reward-based machine learning. Learning may be supervised or unsupervised.

Model implementations may be mathematical, making use of mathematical equations, empirical correlations, statistics, tables, matrices, and the like. Other model implementations may rely more on symbols, knowledge bases, and logic such as rule-based systems. Some implementations are hybrid, utilizing both mathematics and logic. Some models may incorporate random, non-deterministic, or unpredictable elements. Some model implementations may make uses of networks of data values such as neural networks. These are just some examples of models.

The predictive paradigm examples described herein differ from non-predictive approaches where an actuator or other machine parameter is fixed at the time the machine, system, or component is designed, set once before the machine enters the worksite, is reactively adjusted manually based on operator perception, or is reactively adjusted based on a sensor value.

The functional predictive map examples described herein also differ from other map-based approaches. In some examples of these other approaches, an a priori control map is used without any modification based on in-situ sensor data or else a difference determined between data from an in-situ sensor and a predictive map are used to calibrate the in-situ sensor. In some examples of the other approaches, sensor data may be mathematically combined with a priori data to generate control signals, but in a location-agnostic way; that is, an adjustment to an a priori, georeferenced predictive setting is applied independent of the location of the work machine at the worksite. The continued use or end of use of the adjustment, in the other approaches, is not dependent on the work machine being in a particular defined location or region within the worksite.

In examples described herein, the functional predictive maps and predictive actuator control rely on obtained maps and in-situ data that are used to generate predictive models. The predictive models are then revised during the operation to generate revised functional predictive maps and revised actuator control. In some examples, the actuator control is provided based on functional predictive control zone maps which are also revised during the operation at the worksite. In some examples, the revisions (e.g., adjustments, calibrations, etc.) are tied to regions or zones of the worksite rather than to the whole worksite or some non-georeferenced condition. For example, the adjustments are applied to one or more areas of a worksite to which an adjustment is determined to be relevant (e.g., such as by satisfying one or more conditions which may result in application of an adjustment to one or more locations while not applying the adjustment to one or more other locations), as opposed to applying a change in a blanket way to every location in a non-selective way.

In some examples described herein, the models determine and apply those adjustments to selective portions or zones of the worksite based on a set of a priori data, which, in some instances, is multivariate in nature. For example, adjustments may, without limitation, be tied to defined portions of the worksite based on site-specific factors such as topography, soil type, crop variety, soil moisture, as well as various other factors, alone or in combination. Consequently, the adjustments are applied to the portions of the field in which the site-specific factors satisfy one or more criteria and not to other portions of the field where those site-specific factors do not satisfy the one or more criteria. Thus, in some examples described herein, the model generates a revised functional predictive map for at least the current location or zone, the unworked part of the worksite, or the whole worksite.

As an example, in which the adjustment is applied only to certain areas of the field, consider the following. The system may determine that a detected in-situ characteristic value varies from a predictive value of the characteristic, such as by a threshold amount. This deviation may only be detected in areas of the field where the elevation of the worksite is above a certain level. Thus, the revision to the predictive value is only applied to other areas of the worksite having elevation above the certain level. In this simpler example, the predictive characteristic value and elevation at the point the deviation occurred and the detected characteristic value and elevation at the point the deviation cross the threshold are used to generate a linear equation. The linear equation is used to adjust the predictive characteristic value in areas of the worksite (which have not yet been operated on in the current operation, such as unplanted/unseeded or untilled areas) in the functional predictive map as a function of elevation and the predicted characteristic value. This results in a revised functional predictive map in which some values are adjusted while others remain unchanged based on selected criteria, e.g., elevation as well as threshold deviation. The revised functional map is then used to generate a revised functional control zone map for controlling the machine.

As an example, without limitation, consider an instance of the paradigm described herein which is parameterized as follows.

One or more maps of the field are obtained, such as one or more of a topographic map, a residue moisture/toughness map, a soil moisture map, a soil type map, a vegetative index (VI) map, an optical map, a prior harvesting operation map, a prior tillage operation map, a historical yield map, a weed map, and another type of map.

In-situ sensors generate sensor data indicative of in-situ characteristic values, such as in-situ material flow issue (MFI) values.

A predictive model generator generates one or more predictive models based on the one or more obtained maps and the in-situ sensor data, such as a predictive material flow issue (MFI) model.

A predictive map generator generates one or more functional predictive maps based on a model generated by the predictive model generator and the one or more obtained maps. For example, the predictive map generator may generate a functional predictive material flow issue (MFI) map that maps predictive MFI values to one or more locations on the worksite based on a predictive MFI model and the one or more obtained maps.

Control zones, which include machine settings values, can be incorporated into the functional predictive MFI map to generate a functional predictive material flow issue (MFI) map with control zones.

As the mobile machine continues to operate at the worksite, additional in-situ sensor data is collected. A learning trigger criteria can be detected, such as threshold amount of additional in-situ sensor data being collected, a magnitude of change in a relationship (e.g., the in-situ characteristic values varies to a certain [e.g., threshold] degree from a predictive value of the characteristic), and operator or user makes edits to the predictive map(s) or to a control algorithm, or both, a certain (e.g., threshold) amount of time elapses, as well as various other learning trigger criteria. The predictive model(s) are then revised based on the additional in-situ sensor data and the values from the obtained maps. The functional predictive maps or the functional predictive control zone maps, or both, are then revised based on the revised model(s) and the values in the obtained maps.

The present discussion has mentioned processors and servers. In some examples, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. The displays can take a wide variety of different forms and can have a wide variety of different user actuatable operator interface mechanisms disposed thereon. For instance, user actuatable operator interface mechanisms may include text boxes, check boxes, icons, links, drop-down menus, search boxes, etc. The user actuatable operator interface mechanisms can also be actuated in a wide variety of different ways. For instance, they can be actuated using operator interface mechanisms such as a point and click device, such as a track ball or mouse, hardware buttons, switches, a joystick or keyboard, thumb switches or thumb pads, etc., a virtual keyboard or other virtual actuators. In addition, where the screen on which the user actuatable operator interface mechanisms are displayed is a touch sensitive screen, the user actuatable operator interface mechanisms can be actuated using touch gestures. Also, user actuatable operator interface mechanisms can be actuated using speech commands using speech recognition functionality. Speech recognition may be implemented using a speech detection device, such as a microphone, and software that functions to recognize detected speech and execute commands based on the received speech.

A number of data stores have also been discussed. It will be noted the data stores can each be broken into multiple data stores. In some examples, one or more of the data stores may be local to the systems accessing the data stores, one or more of the data stores may all be located remote form a system utilizing the data store, or one or more data stores may be local while others are remote. All of these configurations are contemplated by the present disclosure.

Also, the figures show a number of blocks with functionality ascribed to each block. It will be noted that fewer blocks can be used to illustrate that the functionality ascribed to multiple different blocks is performed by fewer components. Also, more blocks can be used illustrating that the functionality may be distributed among more components. In different examples, some functionality may be added, and some may be removed.

It will be noted that the above discussion has described a variety of different systems, components, logic and interactions. It will be appreciated that any or all of such systems, components, logic and interactions may be implemented by hardware items, such as processors, memory, or other processing components, some of which are described below, that perform the functions associated with those systems, components, or logic, or interactions. In addition, any or all of the systems, components, logic and interactions may be implemented by software that is loaded into a memory and is subsequently executed by a processor or server or other computing component, as described below. Any or all of the systems, components, logic and interactions may also be implemented by different combinations of hardware, software, firmware, etc., some examples of which are described below. These are some examples of different structures that may be used to implement any or all of the systems, components, logic and interactions described above. Other structures may be used as well.

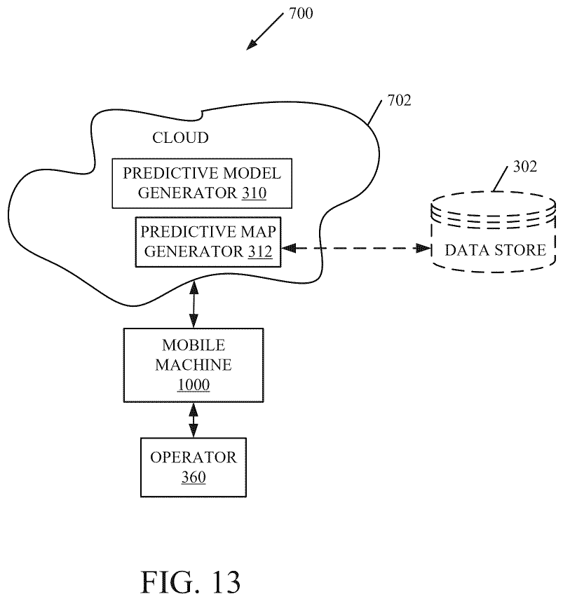

FIG. 13 is a block diagram of mobile ground engaging machine 1000, which may be similar to mobile ground engaging machine 100 shown in FIG. 10. The mobile machine 1000 communicates with elements in a remote server architecture 700. In some examples, remote server architecture 700 provides computation, software, data access, and storage services that do not require end-user knowledge of the physical location or configuration of the system that delivers the services. In various examples, remote servers may deliver the services over a wide area network, such as the internet, using appropriate protocols. For instance, remote servers may deliver applications over a wide area network and may be accessible through a web browser or any other computing component. Software or components shown in FIG. 10 as well as data associated therewith, may be stored on servers at a remote location. The computing resources in a remote server environment may be consolidated at a remote data center location, or the computing resources may be dispersed to a plurality of remote data centers. Remote server infrastructures may deliver services through shared data centers, even though the services appear as a single point of access for the user. Thus, the components and functions described herein may be provided from a remote server at a remote location using a remote server architecture. Alternatively, the components and functions may be provided from a server, or the components and functions can be installed on client devices directly, or in other ways.

In the example shown in FIG. 13, some items are similar to those shown in FIG. 10 and those items are similarly numbered. FIG. 13 specifically shows that predictive model generator 310 or predictive map generator 312, or both, may be located at a server location 702 that is remote from the mobile machine 1000. Therefore, in the example shown in FIG. 13, mobile machine 1000 accesses systems through remote server location 702. In other examples, various other items may also be located at server location 702, such as data store 302, map selector 309, predictive model 311, functional predictive maps 263 (including predictive maps 264 and predictive control zone maps 265), control zone generator 313, and processing system 338.

FIG. 13 also depicts another example of a remote server architecture. FIG. 13 shows that some elements of FIG. 10 may be disposed at a remote server location 702 while others may be located elsewhere. By way of example, data store 302 may be disposed at a location separate from location 702 and accessed via the remote server at location 702. Regardless of where the elements are located, the elements can be accessed directly by mobile machine 1000 through a network such as a wide area network or a local area network; the elements can be hosted at a remote site by a service; or the elements can be provided as a service or accessed by a connection service that resides in a remote location. Also, data may be stored in any location, and the stored data may be accessed by, or forwarded to, operators, users or systems. For instance, physical carriers may be used instead of, or in addition to, electromagnetic wave carriers. In some examples, where wireless telecommunication service coverage is poor or nonexistent, another machine, such as a fuel truck or other mobile machine or vehicle, may have an automated, semi-automated or manual information collection system. As the mobile machine 1000 comes close to the machine containing the information collection system, such as a fuel truck prior to fueling, the information collection system collects the information from the mobile machine 1000 using any type of ad-hoc wireless connection. The collected information may then be forwarded to another network when the machine containing the received information reaches a location where wireless telecommunication service coverage or other wireless coverage-is available. For instance, a fuel truck may enter an area having wireless communication coverage when traveling to a location to fuel other machines or when at a main fuel storage location. All of these architectures are contemplated herein. Further, the information may be stored on the mobile machine 1000 until the mobile machine 1000 enters an area having wireless communication coverage. The mobile machine 1000, itself, may send the information to another network.

It will also be noted that the elements of FIG. 10, or portions thereof, may be disposed on a wide variety of different devices. One or more of those devices may include an on-board computer, an electronic control unit, a display unit, a server, a desktop computer, a laptop computer, a tablet computer, or other mobile device, such as a palm top computer, a cell phone, a smart phone, a multimedia player, a personal digital assistant, etc.

In some examples, remote server architecture 700 may include cybersecurity measures. Without limitation, these measures may include encryption of data on storage devices, encryption of data sent between network nodes, authentication of people or processes accessing data, as well as the use of ledgers for recording metadata, data, data transfers, data accesses, and data transformations. In some examples, the ledgers may be distributed and immutable (e.g., implemented as blockchain).

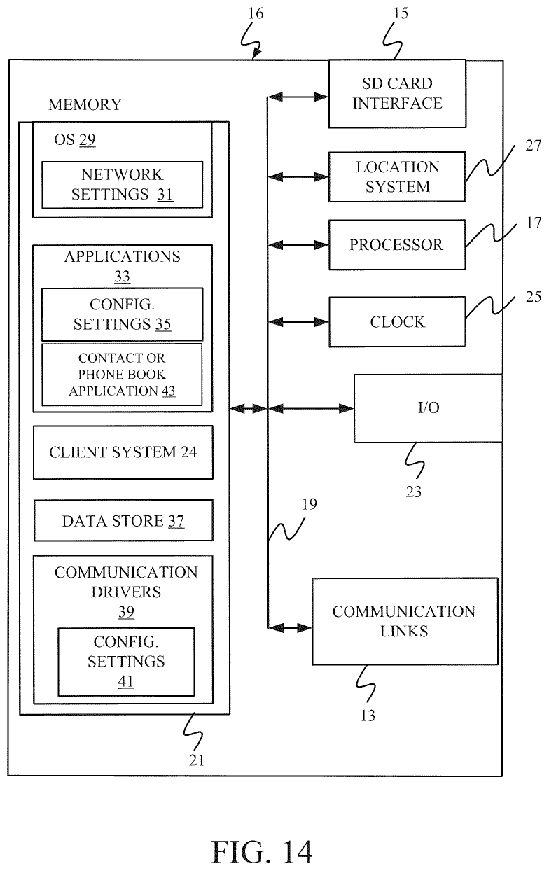

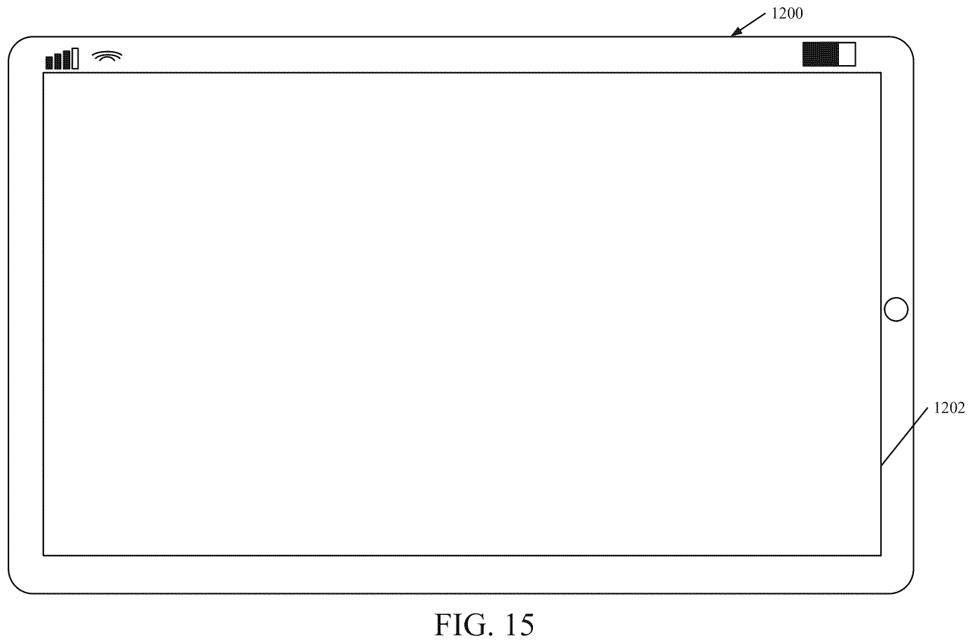

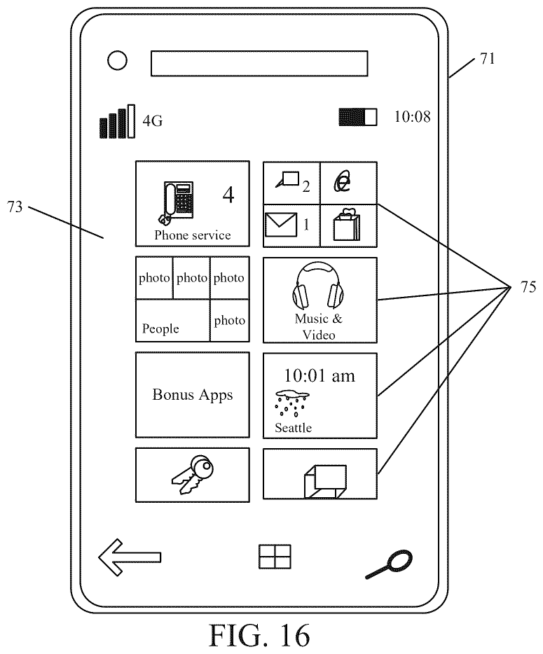

FIG. 14 is a simplified block diagram of one illustrative example of a handheld or mobile computing device that can be used as a user's or client's hand held device 16, in which the present system (or parts of it) can be deployed. For instance, a mobile device can be deployed in the operator compartment of mobile machine 100 for use in generating, processing, or displaying the maps discussed above. FIGS. 15-16 are examples of handheld or mobile devices.

FIG. 14 provides a general block diagram of the components of a client device 16 that can run some components shown in FIG. 10, that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from other FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 may also include computer storage media (described below). Memory 21 stores computer readable instructions that, when executed by processor 17, cause the processor to perform computer-implemented steps or functions according to the instructions. Processor 17 may be activated by other components to facilitate their functionality as well.

FIG. 15 shows one example in which device 16 is a tablet computer 1200. In FIG. 15, computer 1200 is shown with user interface display screen 1202. Screen 1202 can be a touch screen or a pen-enabled interface that receives inputs from a pen or stylus. Tablet computer 1200 may also use an on-screen virtual keyboard. Of course, computer 1200 might also be attached to a keyboard or other user input device through a suitable attachment mechanism, such as a wireless link or USB port, for instance. Computer 1200 may also illustratively receive voice inputs as well.

FIG. 16 is similar to FIG. 15 except that the device is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

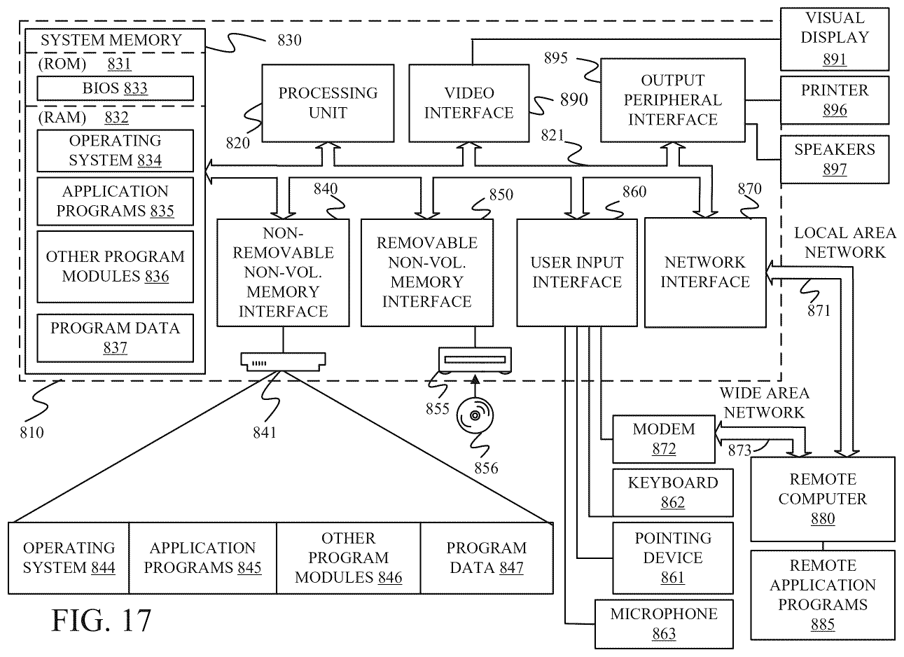

FIG. 17 is one example of a computing environment in which elements of FIG. 10 can be deployed. With reference to FIG. 17, an example system for implementing some embodiments includes a computing device in the form of a computer 810 programmed to operate as discussed above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to FIG. 10 can be deployed in corresponding portions of FIG. 17.

Computer 810 typically includes a variety of computer readable media. Computer readable media may be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer readable media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory or both such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data or program modules or both that are immediately accessible to and/or presently being operated on by processing unit 820. By way of example, and not limitation, FIG. 17 illustrates operating system 834, application programs 835, other program modules 836, and program data 837.

The computer 810 may also include other removable/non-removable volatile/nonvolatile computer storage media. By way of example only, FIG. 17 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 17, provide storage of computer readable instructions, data structures, program modules and other data for the computer 810. In FIG. 17, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network—CAN, local area network—LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 17 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of the claims.

The foregoing description and examples has been set forth merely to illustrate the disclosure and are not intended as being limiting. Each of the disclosed aspects and embodiments of the present disclosure may be considered individually or in combination with other aspects, embodiments, and variations of the disclosure. In addition, unless otherwise specified, none of the steps of the methods of the present disclosure are confined to any particular order of performance. Modifications of the disclosed embodiments incorporating the spirit and substance of the disclosure may occur to persons skilled in the art and such modifications are within the scope of the present disclosure. Furthermore, all references cited herein are incorporated by reference in their entirety.

Terms of orientation used herein, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures, but can encompass structures that are reasonably close approximations.

Conditional language used herein, such as, among others, “can,” “might,” “may,” “e.g.,” and the like, unless specifically stated otherwise, or otherwise understood within the context as used, is generally intended to convey that some embodiments include, while other embodiments do not include, certain features, elements, and/or states. Thus, such conditional language is not generally intended to imply that features, elements, blocks, and/or states are in any way required for one or more embodiments or that one or more embodiments necessarily include logic for deciding, with or without author input or prompting, whether these features, elements and/or states are included or are to be performed in any particular embodiment.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees.

Unless otherwise explicitly stated, articles such as “a” or “an” should generally be interpreted to include one or more described items. Accordingly, phrases such as “a device configured to” are intended to include one or more recited devices. Such one or more recited devices can be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

Although systems and methods for generating functional predictive maps and controlling a machine based on functional predictive maps have been disclosed in the context of certain embodiments and examples, this disclosure extends beyond the specifically disclosed embodiments to other alternative embodiments and/or uses of the embodiments and certain modifications and equivalents thereof. Various features and aspects of the disclosed embodiments can be combined with or substituted for one another in order to form varying modes of systems and methods for generating functional predictive maps and controlling a machine based on functional predictive maps. The scope of this disclosure should not be limited by the particular disclosed embodiments described herein.

Certain features that are described in this disclosure in the context of separate implementations can be implemented in combination in a single implementation. Conversely, various features that are described in the context of a single implementation can be implemented in multiple implementations separately or in any suitable subcombination. Although features may be described herein as acting in certain combinations, one or more features from a claimed combination can, in some cases, be excised from the combination, and the combination may be claimed as any subcombination or variation of any subcombination.

While the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various embodiments described and the appended claims. Further, the disclosure herein of any particular feature, aspect, method, property, characteristic, quality, attribute, element, or the like in connection with an embodiment can be used in all other embodiments set forth herein. Any methods disclosed herein need not be performed in the order recited. Depending on the embodiment, one or more acts, events, or functions of any of the algorithms, methods, or processes described herein can be performed in a different sequence, can be added, merged, or left out altogether (e.g., not all described acts or events are necessary for the practice of the algorithm). In some embodiments, acts or events can be performed concurrently, e.g., through multi-threaded processing, interrupt processing, or multiple processors or processor cores or on other parallel architectures, rather than sequentially. Further, no element, feature, block, or step, or group of elements, features, blocks, or steps, are necessary or indispensable to each embodiment. Additionally, all possible combinations, subcombinations, and rearrangements of systems, methods, features, elements, modules, blocks, and so forth are within the scope of this disclosure. The use of sequential, or time-ordered language, such as “then,” “next,” “after,” “subsequently,” and the like, unless specifically stated otherwise, or otherwise understood within the context as used, is generally intended to facilitate the flow of the text and is not intended to limit the sequence of operations performed. Thus, some embodiments may be performed using the sequence of operations described herein, while other embodiments may be performed following a different sequence of operations.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described herein should not be understood as requiring such separation in all implementations, and it should be understood that the described components and systems can generally be integrated together in a single product or packaged into multiple products. Additionally, other implementations are within the scope of this disclosure.

Some embodiments have been described in connection with the accompanying figures. Certain figures are drawn and/or shown to scale, but such scale should not be limiting, since dimensions and proportions other than what are shown are contemplated and are within the scope of the embodiments disclosed herein. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

The methods disclosed herein may include certain actions taken by a practitioner; however, the methods can also include any third-party instruction of those actions, either expressly or by implication. For example, actions such as “positioning an electrode” include “instructing positioning of an electrode.”

The ranges disclosed herein also encompass any and all overlap, subranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 1 V” includes “1 V.” Phrases preceded by a term such as “substantially” include the recited phrase and should be interpreted based on the circumstances (e.g., as much as reasonably possible under the circumstances). For example, “substantially perpendicular” includes “perpendicular.” Unless stated otherwise, all measurements are at standard conditions including temperature and pressure.

In summary, various embodiments and examples of systems and methods for generating functional predictive maps and controlling a machine based on functional predictive maps, have been disclosed. Although the systems and methods for generating functional predictive maps and controlling a machine based on functional predictive maps have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular disclosed embodiments described herein, but should be determined only by a fair reading of the claims that follow.

1.-20. (canceled)

21. An agricultural ground engaging system comprising:
a control system that:
obtains a geographic location indicative of a geographic location of a mobile ground engaging machine at a field;
obtains a map that maps predictive material flow issue values to different geographic locations in the field; and
generates a control signal to control a controllable subsystem of the mobile ground engaging machine based on the geographic location of the mobile ground engaging machine and the map.

22. The agricultural ground engaging system of claim 21 and further comprising:
an in-situ sensor that detects a material flow issue value corresponding to a geographic location;
a predictive model generator that:
receives an information map that maps values of a characteristic corresponding to different geographic locations in the field;
generates a predictive material flow issue model that models a relationship between values of the characteristic and material flow issue values based on the material flow issue value detected by the in-situ sensor corresponding to the geographic location and a value of the characteristic in the information map at the geographic location to which the detected material flow issue value corresponds; and
a predictive map generator that generates, as the map, a functional predictive material flow issue map of the field that maps predictive material flow issue values to the different geographic locations in the field, based on the values of the characteristic in the information map and based on the predictive material flow model.

23. The agricultural ground engaging system of claim 22 wherein the information map comprises one of:
a topographic map that maps, as the values of the characteristic, topographic characteristic values to the different geographic locations in the field;
a residue moisture/toughness map that maps, as the values of the characteristic, residue moisture/toughness values to the different geographic locations in the field;
a soil moisture map that maps, as the values of the characteristic, soil moisture values to the different geographic locations in the field;
a soil type map that maps, as the values of the characteristic, soil type values to the different geographic locations in the field;
a vegetative index map that maps, as the values of the characteristic, vegetative index values to the different geographic locations in the field;
an optical map that maps, as the values of the characteristic, optical characteristic values to the different geographic locations in the field;
a prior harvesting operation map that maps, as the values of the characteristic, prior harvesting operation characteristic values to the different geographic locations in the field;
a prior tillage operation map that maps, as the values of the characteristic, prior tillage operation characteristic values to the different geographic locations in the field;
a historical yield map that maps, as the values of the characteristic, historical yield values to the different geographic locations in the field; or
a weed map that maps, as the values of the characteristic, weed values to the different geographic locations in the field.

24. The agricultural ground engaging system of claim 21, wherein the controllable subsystem comprises a tool position subsystem having an actuator that is controllably actuatable to adjust a position of a tool of the mobile ground engaging machine, and wherein the control signal controls the actuator to adjust a position of the tool based on the geographic location of the mobile ground engaging machine and the map.

25. The agricultural ground engaging system of claim 21, wherein the controllable subsystem comprises a propulsion subsystem that is controllable to adjust a speed of the mobile ground engaging machine, and wherein the control signal controls the propulsion subsystem to adjust a speed of the mobile ground engaging machine based on the geographic location of the mobile ground engaging machine and the map.

26. The agricultural ground engaging system of claim 21, wherein the controllable subsystem comprises a downforce subsystem having an actuator that is controllably actuatable to adjust a downforce applied to a component of the ground engaging machine, and wherein the control signal controls the actuator to adjust a downforce applied to the tool based on the geographic location of the mobile ground engaging machine and the map.

27. The agricultural ground engaging system of claim 21, wherein the controllable subsystem comprises a steering subsystem having that is controllable to control a travel path of the mobile ground engaging machine, and wherein the control signal controls the steering subsystem to control a travel path of the mobile ground engaging machine based on the geographic location of the mobile ground engaging machine and the map.

28. The agricultural ground engaging system of claim 21, wherein the predictive material flow issue values are predictive of material accumulation on a ground engaging tool of the ground engaging machine.

29. The agricultural ground engaging system of claim 21, wherein the predictive material flow issue values are predictive of plugging of a ground engaging tool or ground engaging tool assembly of the ground engaging machine.

30. A method of controlling a mobile ground engaging machine comprising:
receiving a predictive map of a field that maps predictive material flow issue values to different geographic locations in the field;
detecting a geographic location of the mobile ground engaging machine at the field; and
controlling the mobile ground engaging machine based on the geographic location of the mobile ground engaging machine and the predictive map.

31. The method of claim 30 wherein receiving the predictive map comprises:
detecting, with an in-situ sensor, a material flow issue value corresponding to a geographic location in the field;
receiving an information map that maps values a characteristic corresponding to the different geographic locations in the field;
generating a predictive material flow issue model that models a relationship between material flow issue values and values of the characteristic based on the detected material flow issue value and a value of the characteristic, in the information map, at the geographic location to which the material flow issue, detected by the in-situ sensor, corresponds; and
generating, as the predictive map, a functional predictive material flow issue map of the field, that maps predictive material flow issue values to the different geographic locations in the field based on values of the characteristic in an information map at those different geographic locations and the predictive material flow issue model.

32. The method of claim 31 wherein receiving the information map comprises receiving two or more information maps, each of the two or more information maps mapping values of a respective characteristic to the different geographic locations in the field;
wherein generating the predictive material flow issue model comprises, generating a predictive material flow issue model that models a relationship between the material flow issue values, and values of two or more respective characteristics based on the detected material flow issue value and a value of each of the two or more respective characteristics, in the two or more information maps, at the geographic location to which the material flow issue, detected by the in-situ sensor, corresponds; and
wherein generating the functional predictive material flow issue map comprises, generating a predictive material flow issue map that maps predictive material flow issue values to the different geographic locations in the field based on values of the two or more respective characteristics in the two or more information maps at those different locations and the predictive material flow issue model.

33. The method of claim 31, wherein controlling the ground engaging machine comprises controlling a tool position actuator to control a position of a tool of the mobile ground engaging machine, based on the functional predictive material flow issue map and the geographic location of the mobile ground engaging machine.

34. The method of claim 31, wherein controlling the ground engaging machine comprises controlling a downforce actuator to control a downforce applied to a tool the mobile ground engaging machine, based on the functional predictive material flow issue map and the geographic location of the mobile ground engaging machine.

35. The method of claim 31, wherein controlling the ground engaging machine comprises controlling a steering subsystem of the mobile ground engaging machine, based on the functional predictive material flow issue map and the geographic location of the mobile ground engaging machine.

36. A mobile ground engaging machine comprising:
a controllable subsystem;
a geographic position sensor that detects a geographic location of the mobile ground engaging machine in a field; and
a control system that:
obtains a map of the field that maps predictive material flow issue values to different geographic locations in the field; and
generates a control signal to control the controllable subsystem based on the geographic location of the mobile ground engaging machine and a predictive material flow issue value in the map.

37. The mobile ground engaging machine of claim 36 and further comprising:
a communication system that receives an information map that includes values of a characteristic corresponding to the different geographic locations in the field;
an in-situ sensor that detects a material flow issue value corresponding to a geographic location at the field;
a predictive model generator that generates a predictive material flow issue model that models a relationship between the characteristic and the material flow issue based on the material flow issue value, detected by the in-situ sensor, corresponding to the geographic location and a value of the characteristic in the information map at the geographic location to which the detected material flow issue value corresponds; and
a predictive map generator that generates, as the map, a functional predictive material flow issue map of the field, that maps predictive material flow issue values to the different geographic locations in the field, based on the values of the characteristic in the information map and based on the predictive material flow issue model.

38. The mobile ground engaging machine of claim 36, wherein the controllable subsystem comprises a tool position subsystem that is controllable to vary a position of a ground engaging tool of the mobile ground engaging machine and wherein the control signal controls the tool position subsystem to adjust a position of the ground engaging tool based on the geographic location of the mobile ground engaging machine and the predictive material flow issue value in the map.

39. The mobile ground engaging machine of claim 36, wherein the controllable subsystem comprises a downforce subsystem that is controllable to adjust a downforce applied to a component of the mobile ground engaging machine and wherein the control signal controls the downforce subsystem to adjust a downforce applied to the component based on the geographic location of the mobile ground engaging machine and the predictive material flow issue value in the map.

40. The mobile ground engaging machine of claim 36, wherein the controllable subsystem comprises a steering subsystem that is controllable to adjust a route of the mobile ground engaging machine and wherein the control signal controls the steering subsystem to adjust a route of the mobile ground engaging machine based on the geographic location of the mobile ground engaging machine and the predictive material flow issue value in the map.
